(19) United States
(12) Patent Application Publication
(10) Pub. No.: US 2019/0344254 A1
(43) Pub. Date: Nov. 14, 2019

(54) CYCLIC SUPPORTED CATALYSTS

(71) Applicants: UNIVERSITE PARIS-SUD, Orsay Cedex (FR); CENTRE NATIONAL DE LA RECHERCHE SCIENTIFIQUE, Paris Cedex (FR)

(72) Inventors: Vincent Germain HUC, Orsay (FR); Cyril August Roger MARTINI, Villebon Dur Yvette (FR); Ibrahim ABDELLAH, Gif Sur Yvette (FR); Emmanuelle SCHULZ, Saint Remy Les Chevreuse (FR)

(21) Appl. No.: 16/345,581

(22) PCT Filed: Oct. 27, 2017
(86) PCT No.: PCT/FR2017/052980

§ 371 Date: Jun. 6, 2019

(30) Foreign Application Priority Data
Oct. 27, 2016 (FR) 16/60471

(51) Int. Cl. B01J 31/22; B01J 31/18; C07F 15/00; C07F 15/06

(52) U.S. Cl. CPC B01J 31/2273; B01J 31/181; B01J 31/226; B01J 31/2213; B01J 2231/645; C07F 15/065; B01J 2531/824; B01J 2531/845; B01J 2231/4211; C07F 15/006

(57) ABSTRACT

The present invention relates to ligands based on calixarenes, metal complexes including such ligands and their use as homogeneous or heterogeneous catalysts.

The present invention relates to ligands based on calixarenes, metal complexes comprising such ligands and their use as homogeneous or heterogeneous catalysts.

Metal catalysis represents, however, a way to accelerate or make possible certain reactions and access a large number of compounds at production costs much lower than the conventional routes of organic synthesis (sometimes requiring a large number of steps).

Requirements with respect to residual metals in products for human use, particularly in products for pharmaceutical use, are at present an obstacle for the use of metal deactivators in the manufacture of such products. For example, the residual ratio of transition metals of classes 1A and 1 B must be less than 10 ppm for oral administration and less than 1 ppm for parenteral administration.

Various ways have been proposed to reduce the amount of metal in the finished product without the need for costly and/or tedious purification steps.

Among these methods, heterogeneous catalysis is a way of primary importance. The disadvantage of heterogeneous catalysts, however, is their inferior performance compared to similar homogeneous catalysts. Conversely, the use of homogeneous catalysts that may be separated from the finished product by simple filtration after the reaction in which they were engaged (or after a precipitation step or by ultrafiltration) is an alternative which was explored. Common to these two pathways is the leaching of metal in the solution due to decomplexation of the ligand, and therefore its presence in the final product.

An object of the present invention is a catalyst having a high catalytic activity compared to the existing catalysts.

Another object of the invention is a catalyst capable of being used as a homogeneous catalyst or as a heterogeneous catalyst readily separable product.

A still further object of the present invention is a catalyst capable of greatly reducing the leaching of metal during the reaction in which it is engaged and obtaining finished products containing a very small amount of metal, in particular less than 100 ppm, or even less than 10 or 5 ppm.

The present invention relates to a compound of general formula (I):

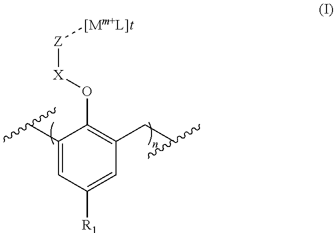

in which:

n represents an integer from 7 to 20 or greater than 20, in particular 21 to 220,

X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, the aryl being in particular selected from phenyl and naphthyl,

R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,

M^{m+} is a metal in oxidation state m or a metal cluster comprising a plurality of metals in the oxidation state m, where m is 0, 1, 2, 3, 4 or 5, in particular 0, 1, 2 or 3,

L consists of one or more neutral ligands or negatively charged linked to the metal, and said compound has the formula (IA) in which t is 0 and Z represents a group Q selected from the group consisting of phosphorus ligands such as the phosphonites and phosphinites, with the exception of phosphines and phosphine oxides, N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes, or salen ligands, said compound has the formula (IB) in which t is 0 and Z represents a group Q′, a precursor of a group Q selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides, or chalcogenides, in particular phosphine sulfides, or salen ligands precursors, in particular derivatives of salicylaldehyde, said compound has the formula (IC) wherein t is 1 and Z represents a group Q selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4 triazolylidenes and 1,3-thiazolylidenes, or salen ligands.

Within the meaning of the present invention, the term “linear or branched alkyl comprising 1 to 10 carbon atoms” an acyclic carbon chain, saturated, linear or branched, comprising 1 to 10 carbon atoms. This is methyl, ethyl, propyl, butyl, pentyl, hexyl, heptyl, octyl, nonyl and decyl. The definition of propyl, butyl, pentyl, hexyl, heptyl, octyl, nonyl and decyl include all possible isomers. For example, the term butyl includes n-butyl, iso-butyl, sec-butyl and tert-butyl. One or more hydrogen atoms may be substituted in the alkyl chain with a fluorine atom or a CF₃ group.

Within the meaning of the present invention, the term “ethylene glycol unit” a group of formula —CH₂—CH₂—O. A polyethylene glycol having 1-5 ethylene glycol units is thus a chain of formula —(CH₂—CH₂)ₙ—CH₃ where n is 1 to 5.

Within the meaning of the present invention, the term “aryl” an aromatic monocycle comprising from 5 to 6 carbon atoms, which may itself be fused with a second saturated, unsaturated or aromatic. The term aryl includes, without limitation, phenyl and its derivatives in which one or more hydrogen atoms have been replaced by a group independently selected from alkyl, halogen, alkyl, halogen, hydroxyl, alkoxy, amino, amido, nitro, cyano, trifluoromethyl, carboxylic acid or carboxylic ester and naphthyl. Examples of substituted aryls include, without limitation, 2-, 3- or 4-(N, N-dimethylamino)phenyl, 2-, 3- or 4-cyanophenyl, 2-, 3- or 4-nitrophenyl, 2-, 3- or 4-fluoro-, chloro-, bromo- or iodo-phenyl, 2-, 3- or 4-methoxyphenyl.

Within the meaning of the present invention, the expression (straight or branched alkyl containing from 1 to 10 carbon atoms)-aryl, a group comprising an acyclic carbon chain, saturated, linear or branched, comprising 1 to 10 carbon atoms such as defined above linked to an aryl. Examples of linear or branched alkyl comprising 1 to 10 carbon atoms)-aryl include benzyl and homobenzyles groups.

For the purposes of this invention, “M^{m+}” represents a metal atom in the oxidation state 0, 1, 2, 3, 4 or 5, in particular 0, 1, 2 or 3. The said metal atom is linked to as ligands as required to obtain a stable and neutral species. For example, when the metal is palladium in the oxidation state 2, it can be linked to two chloride ions, the Q moiety of the compounds according to the present invention and another ligand L, such as a pyridine or one of its derivatives. The nature of the ligands to which the metal M is bound varies depending on the metal precursor and the conditions used for the preparation of the metal complex. The metal M can also be part of a metal cluster or cluster. Examples of such aggregates include metal carbonyls aggregates in particular triruthenium dodecacarbonyl Ru₃(CO)₁₂.

The N-heterocyclic carbenes are well known to the skilled person and have been the subject of magazine articles and books. We may mention in particular reference to the N-heterocyclic carbenes the book N-Heterocyclic carbenes: Effective Tools for Organometallic Synthesis (Steven P. Nolan Editor; ISBN: 978-3-527-33490-2).

N-heterocyclic carbenes have the following general formula (M representing a metal which they are attached):

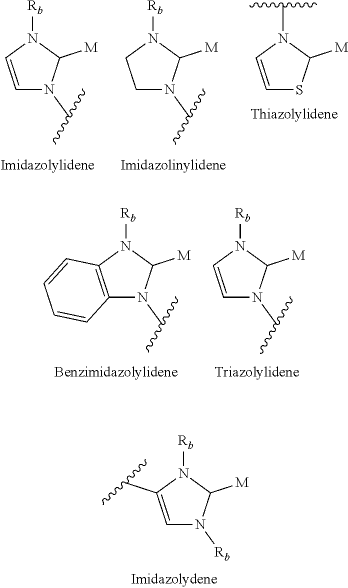

in which:

R_{b} is selected from but not limited to:
alkyl such as i-propyl and adamantyl,
groups of formula CH₂—COOR_{c} in which R_{c} is alkyl or aryl,
aryl such as phenyl, optionally substituted in particular by one or more alkyl, in particular methyl or i-propyl, one or more alkoxy, in particular methoxy, and
heteroaryl such as pyridyl, furyl, pyrrolyl and indolyl.

Within the meaning of the present invention, the term “phosphine” a compound of formula PR₂ bonded to the rest of the calix[n]arene by the phosphorus atom. Not limited to include, as a group R:
alkyl such as methyl, ethyl, propyl, n-butyl, t-butyl, octyl, cyclohexyl, adamantyl,
aryl such as phenyl, optionally substituted in particular by one or more alkyl, in particular methyl, one or more alkoxy, in particular methoxy, naphthyl optionally substituted,
heteroaryl such as pyridyl, furyl, pyrrolyl and indolyl, or
The two R groups may together form a carbocycle.

Many examples of phosphines are known in the prior art and the corresponding ligands can be introduced by the skilled person from the teaching of the present application.

More advantageously, the phosphine is selected from the group consisting of dicyclohexylphosphine, diphenylphosphine and di-tert-butylphosphine.

Within the meaning of the present invention, the term “phosphonite” a compound of formula P(OR)₂, wherein R is as defined for the above phosphines.

Within the meaning of the present invention, the term “phosphinite” a compound of formula PRₐ(OR), wherein Rₐ and R, independently of one another are as defined for the above phosphines.

Within the meaning of the present invention, the term “salen ligand” a compound of formula

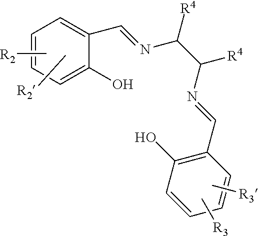

in which:

the groups R₂, R₂′, R₃, R₃′ and R₄ are selected from:
Alkyls such as methyl, ethyl, propyl, n-butyl, t-butyl, octyl, cyclohexyl, adamantyl,
aryl such as phenyl, optionally substituted in particular by one or more alkyl, in particular methyl, one or more alkoxy, in particular methoxy, naphthyl optionally substituted,
heteroaryl such as pyridyl, furyl, pyrrolyl and indolyl, or
the two R groups can together form a carbocycle
   linked to the rest of the calix[n]arene via one of the groups R₂, R₂′, R₃ or R₃′.

The carbon bearing R₄ groups can be racemic, enantioenriched or enantiopure.

In a particular embodiment, the present invention relates to a compound of general formula (I):

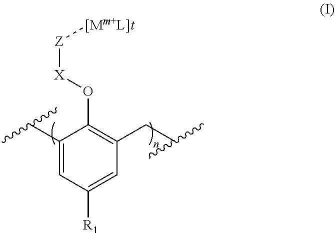

in which:

n represents an integer from 7 to 20 or greater than 20, in particular 21 to 220,

X is a linear or branched alkyl comprising 1 to 10 carbon atoms, a polyethylene glycol comprising from 1 to 5 ethylene glycol units or (linear or branched alkyl comprising from 0 to 10 carbon atoms)-aryl, the aryl being in particular selected from phenyl and naphthyl,

R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,

M^{m+} is a metal in oxidation state m or a metal cluster comprising a plurality of metals in the oxidation state m, where m is 0, 1, 2, 3, 4 or 5, in particular 0, 1, 2 or 3,

L consists of one or more neutral ligands or negatively charged linked to the metal, and said compound has the formula (IA) in which t is 0 and Z represents a group Q selected from the group consisting of phosphorus ligands such as the phosphonites and phosphinites, with the exception of phosphines and phosphine oxides, N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes,

said compound has the formula (IB) in which t is 0 and Z represents a group Q′, a precursor of a group Q selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, in particular phosphine sulfides

said compound has the formula (IC) wherein t is 1 and Z represents a group Q selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

In one embodiment the calix[n]arenes according to the present invention contain from 7 to 20 phenolic units. These calixarenes can be isolated in pure form or be in the form of mixtures comprising calixarenes of different sizes.

In an advantageous embodiment, the calixarenes are in pure form.

More advantageously, the calixarenes of the present invention are calix[8]arenes and calix[16]arenes.

In another embodiment, calixarenes contain more than 20 phenolic units, in particular 21-220 phenolic units. These so-called “wide” or “giant” calixarenes are in particular prepared according to the method described in international applications WO 2014/033407 and WO 2014/033406. They are isolated as a mixture of calixarenes and the number n thus indicates an average number of phenolic units.

Advantageously, the calixarenes of the present invention in which n is greater than 20 contain 21 to 35, 35 to 50, 51 to 199 or 100 to 220 phenolic units. More preferably, the average number of phenolic units in these calixarenes is about 35.

In the compounds according to the present invention, the group X is preferably a linear alkyl chain comprising from 2 to 8 or from 3 to 8 carbon atoms, in particular 2, 3, 4, 5, 6, 7 or 8. More advantageously said linear akyl chain comprises from 3 to 6 carbon atoms. In a particular embodiment, the group X is a linear alkyl having 3 or 4 carbon atoms, in particular 4 carbon atoms. The present invention therefore relates to a compound of formula (I) as defined above, wherein X is a linear alkyl comprising from 2 to 8 or 3 to 8 carbon atoms, in particular from 2 to 6 or from 3 to 6 carbon atoms, preferably 3 or 4 carbon atoms.

In the compounds according to the present invention, the group R₁ is preferably selected from n-octyl, t-butyl, O-benzyl and O-alkyl in particular O-methyl, O-ethyl, O-propyl and O-n-octyl, preferably t-butyl O-benzyl. In a particular embodiment, R₁ is O-benzyl.

In one embodiment, the compounds according to the present invention are in the form of a mixture of at least two compounds of formula (IA), at least two compounds of formula (IB) or a mixture of at least two compounds of formula (IC).

A first object of the present invention relates to ligands based on a pattern calix[n]arene, said ligands having the general formula (IA) below:

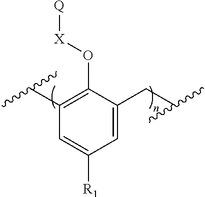

in which:

n, X, R₁ are as defined above.

In the compounds of formula (IA), the group Q is selected from the group of phosphorus ligands such as the phosphonites and phosphinites, with the exception of phosphines and phosphine oxides, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

In the compounds of formula (IA), the compounds are therefore able to bind to metal M.

A second object of the present invention is a compound of formula (IB) below:

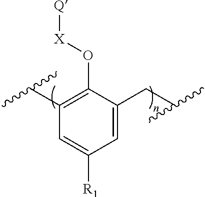

in which:

n, X and R₁ are as defined above.

In the compounds of formula (IB), the group Q′ is a precursor of a group Q selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, particularly the phosphine sulfides.

The term “precursor of a group Q” is meant within the meaning of the present invention that the moiety Q′ is likely to lead to the group Q prior to its association with the metal or simultaneous binding with the metal. For example, the compound of formula (IB) wherein Q is an imidazolium can lead to the formation of the compound of formula (IA) wherein Q is an imidazolylidene by reaction with a base such as an alkoxide, in particular the t butoxide or sodium.

phosphine oxides are an example of phosphine precursors. They are particularly useful in the case of highly sensitive to moisture and/or oxygen phosphines such as dialkylphosphines as e.g. dicyclohexylphosphine or di-t-butylphosphine.

Preferably, Q′ is an azolium selected from the group consisting of 1,3-imidazolium, the 1,3-imidazolinium, of 1,2,4-triazolium, of 1,3-benzimidazolium and 1,3-thiazolium. These include an imidazolium aryl, aryl being in particular the 1,3,5-mesityl or 2,6-diisopropyl-phenyl.

A third object of the present invention is a metal complex comprising a ligand of formula (IA) as defined above. Within the meaning of the present invention, the term “metal complex” means a compound comprising a compound of formula (IA) wherein at least one of Q groups is bonded to a metal atom M, preferably having the oxidation state 0, 1, 2, 3, 4 or 5, in particular 0, 1, 2 or 3.

Unexpectedly, the inventors of the present invention have revealed that compounds containing much metal M that of the formula Q ligand can be obtained with the ligands according to the present invention.

The number of metal atoms M depends of course on the nature of the ligand, the metal and the stoichiometry (that is to say the ratio M/Q). For example, in the case where the metal is rhodium and Q represents a phosphine and in the case where the metal is palladium and Q represents an imidazolylidene, metal complexes containing 8 metal atoms were obtained with the calix[8]arene.

The metal complexes according to the present invention therefore in particular formula (IC) as follows:

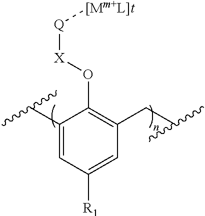

in which:

n, X, M^{m+}, R₁ and L are as defined above,

t is 1,

Q is selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

The Q group is in particular a 1,3-imidazolylidene, in particular an aryl-imidazolylidene wherein the aryl is in particular the 1,3,5-mesityl or 2,6-diisopropyl-phenyl. Advantageously, the metal complexes according to the present invention, particularly of formula (IC) contain at least one transition metal belonging to Group IB, IIB, IIIB, IVB, VB, VIB, VIIB or VIIIB.

More preferably, the metal is selected from metals known to possess catalytic activity. These include a metal selected from the group consisting of Mn, Cr, Fe, Co, Ni, Pd, Ru, Rh, Au, Pt, Cu, Ag, Bi, Re, Mo, Ir, V, Cd and Zn, in particular a metal selected from the group consisting of Ni, Pd, Ru, Rh, Cu, Co or Pt.

Even more advantageously, the metal is selected from the group consisting of Pd⁰, Pd²⁺, Rh⁰, Rh¹⁺, Rh³⁺, Co²⁺, Co³⁺, Ru⁰ and Ru²⁺. The metal may also be part of a metal cluster such as Ru₃(CO)₁₂.

In an advantageous embodiment, the present invention relates to a metal complex wherein each Q moiety is bonded to a single atom M. The present invention therefore relates to a metal complex in which the number of metals M is equal to n of the calix[n]arene of the formula (IC) as follows:

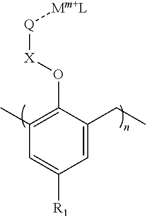

in which:

n, X and R₁ are as defined above,

Q is selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes,

M^{m+} is a metal in oxidation state m or a metal cluster comprising a plurality of metals in the oxidation state m, where m is 0, 1, 2, 3, 4 or 5, in particular 0, 1, 2 or 3, L is composed of one or more neutral or negatively charged ligands bound to the metal.

M^{m+} L group in the complex may be in particular Ru₃(CO)₁₂, (norbornadiene)RhCl, (cyclooctadiene)RhCl, RhCl₃, PdCl₂, complex obtained from the Pd(dba)₂. Other transition metal complexes with phosphines or carbenes are known and can be prepared by the skilled person by applying the teaching of this application.

The present invention also relates to a compound of formula (IC):

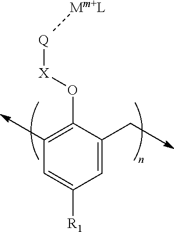

in which:

n, X, R₁ are as defined above,

Q is selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes,

M^{m+} is a metal in oxidation state m or a metal cluster comprising a plurality of metals in the oxidation state m, where m is 0, 1, 2, 3, 4 or 5, in particular 0, 1, 2 or 3 and in particular a transition metal group IB, IIB, IIIB, VA, IVB, VB, VIB, VIIB or VIIIB, in particular selected from the group consisting of Ni, Pd, Ru, Rh, Cu, Co or Pt, and

L consists of one or more neutral ligands or negatively charged linked to the metal.

The present invention also relates to a compound of formula (IC) selected from compounds of the following formula:

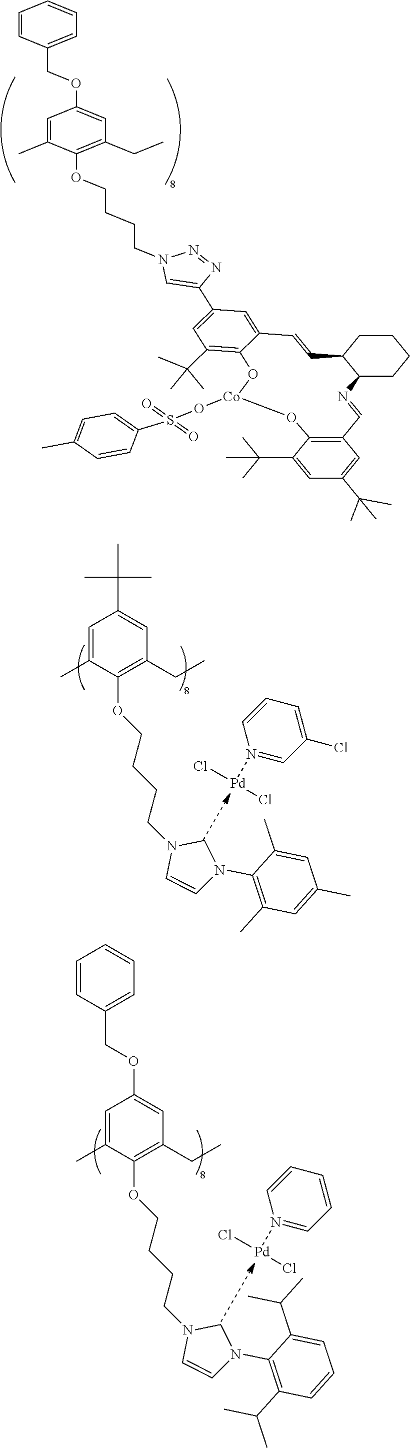

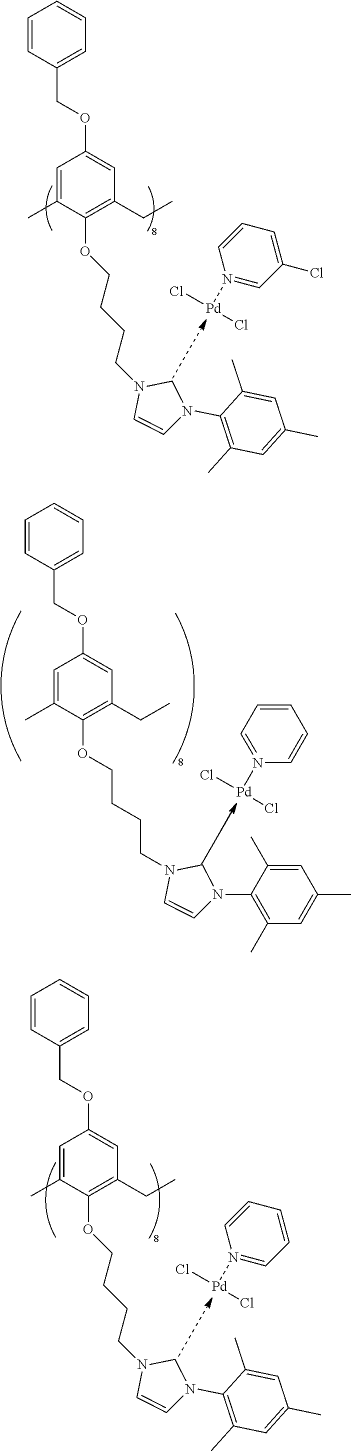

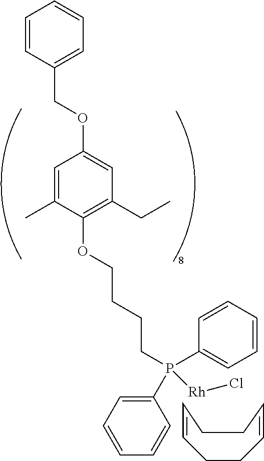

Said compound of formula (IC) may be in the form of a solution in a solvent chosen in particular from the group consisting of DMF, DMSO, THF, NMP, dioxane, toluene, chloroform and dichloromethane.

Said compound of formula (IC) may also be in the form of a suspension in a solvent chosen in particular from the group consisting of alcohols, such as methanol, ethanol, isopropanol and butanol, water or a mixture of these solvents.

The compound of formula (IC) may also be in the form of a dry solid.

In a first particular embodiment, the present invention relates to a compound of formula (IA1) wherein:

n represents an integer from 7 to 20,

X is a linear alkyl having 3 to 6 carbon atoms,

t is 0 and Z represents a group Q selected from the group consisting of phosphorus ligands, in particular phosphonites and phosphinites, with the exception of phosphines and phosphine oxides and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes, preferably a phosphine or 1,3-imidazolylidene,

R₁ represents n-octyl, t-butyl, O-benzyl or O-alkyl in particular O-methyl, O-ethyl, O-propyl or O-n-octyl preferably t-butyl or O-benzyl,

or a precursor of said compound of formula (IA1) of formula (IB1) wherein Q′ is selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, particularly phosphine sulfides, preferably 1,3-imidazolium or a phosphine oxide,

or a metal complex comprising a compound of formula (IA1), in particular of formula (IC1) wherein:

M^{m+} is a metal in oxidation state m or a metal cluster comprising a plurality of metals in the oxidation state m, where m is 0, 1, 2, 3, 4 or 5, in particular 0, 1, 2 or 3.

In a second particular embodiment, the present invention relates to a compound of formula (IA2) wherein:

n represents an integer from 7 to 20, X is a linear alkyl having 4 carbon atoms,

t is 0 and Z represents a group Q selected from the group consisting of phosphorus ligands, in particular phosphonites and phosphinites, with the exception of phosphines and phosphine oxides and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes, preferably a phosphine or 1,3-imidazolylidene,

R₁ represents n-octyl, t-butyl, O-benzyl or O-alkyl in particular O-methyl, O-ethyl, O-propyl or O-n-octyl preferably t-butyl or O-benzyl,

or a precursor of said compound of formula (IA2) corresponding to formula (IB2) wherein Q′ is selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, particularly phosphine sulfides, preferably 1,3-imidazolium or a phosphine oxide,

or a metal complex comprising a compound of formula (IA2), in particular of formula (IC2) in which:

M^{m+} is a metal in oxidation state m or a metal cluster comprising a plurality of metals in the oxidation state m, where m is 0, 1, 2, 3, 4 or 5, in particular 0, 1, 2 or 3.

In a third particular embodiment, the present invention relates to a compound of formula (IA3) below, wherein:

n is 8,

X is a linear alkyl having 4 carbon atoms,

t is 0 and Z represents a group Q selected from the group consisting of phosphorus ligands, in particular phosphonites and phosphinites, with the exception of phosphines and phosphine oxides and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes, preferably a phosphine or 1,3-imidazolylidene,

R₁ represents n-octyl, t-butyl, O-benzyl or O-alkyl in particular O-methyl, O-ethyl, O-propyl or O-n-octyl preferably t-butyl or O-benzyl,

or a precursor of said compound of formula (IA3) of formula (IB3) in which Q′ is selected from the group consisting of azoliums such as 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, particularly phosphine sulfides, preferably 1,3-imidazolium or a phosphine oxide,

or a metal complex comprising a compound of formula (IA3), in particular of formula (IC3) in which:

M^{m+} is a metal in oxidation state m or a metal cluster comprising a plurality of metals in the oxidation state m, where m is 0, 1, 2, 3, 4 or 5, in particular 0, 1, 2 or 3.

A fourth object of the present invention relates to a compound of general formula (I):

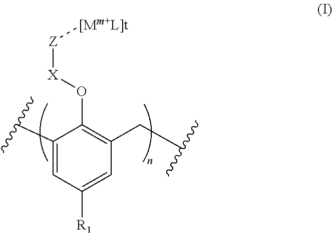

in which:

n represents an integer from 7 to 20 or greater than 20, in particular 21 to 220,

X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, the aryl being in particular selected from phenyl and naphthyl,

R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,

M^{m+} is a metal in oxidation state m or a metal cluster comprising a plurality of metals in the oxidation state m, where m is 0, 1, 2, 3, 4 or 5, in particular 0, 1, 2 or 3,

L consists of one or more neutral ligands or negatively charged linked to the metal, and said compound has the formula (IA) in which t is 0 and Z represents a group Q selected from the group consisting of salen ligands, in particular enantiopure salen ligands, in particular derivatives of cyclohexyldiamine and diphenylethylene and derivatives of the above salen ligands,

said compound has the formula (IB) in which t is 0 and Z represents a group Q′, a precursor of a group Q selected from the group consisting of precursors of salen ligands, in particular derivatives of salicylaldehyde,

said compound has the formula (IC) wherein t is 1 and Z represents a group Q selected from the group consisting of salen ligands, in particular enantiopure salen ligands, in particular derivatives of cyclohexyldiamine and diphenylethylene and derivatives of the above salen ligands.

In an advantageous embodiment, the present invention relates to ligands based on a pattern calix[n]arene, said ligands having the general formula (IA) below:

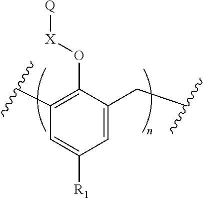

in which:

n, X, R₁ are as defined above,

the Q moiety is selected from the group consisting of salen ligands, in particular enantiopure salen ligands, in particular derivatives of cyclohexyldiamine and diphenylethylene and derivatives of the above salen ligands.

In an advantageous embodiment, the present invention is a compound of formula (IB) below:

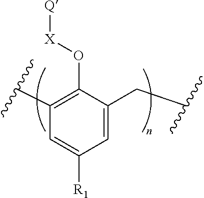

in which:

n, X and R₁ are as defined above,

the group Q′ is a precursor of a group Q selected from the group consisting of precursors of salen ligands, in particular derivatives of salicylaldehyde.

In an advantageous embodiment, the present invention is a compound of formula (IC) as follows:

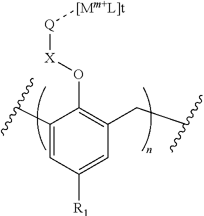

in which:

n, X, M^{m+}, R₁ and L are as defined above,

t is 1,

Q is selected from the group consisting of salen ligands, in particular enantiopure salen ligands, in particular derivatives of cyclohexyldiamine and diphenylethylene and derivatives of the above salen ligands. A fifth object of the present invention relates to the use of a compound of formula (IC) as defined above as a catalyst in an organic chemistry reaction.

The compounds according to the present invention, because of their particular solubility, may be used either as homogeneous catalysts or as heterogeneous catalysts.

The compounds of formula (IA), (IB) and (IC) as defined above are in fact soluble in certain solvents and are not in others.

In one embodiment, the compounds of formula (IC) may be employed as homogeneous catalysts in a solvent in which they are soluble. Mention may be made, as examples of usable solvents for homogeneous catalysis DMF, DMSO, THF, dioxane, NMP, toluene, chloroform and dichloromethane.

When used as homogeneous catalysts, the compounds of formula (IC) can be separated by filtration of the final product by adding to the reaction medium a solvent in which they are not soluble and wherein the product of the chemical reaction organic is soluble. Examples of such solvents are alcohols, water or a mixture of these solvents. The compound of formula (IC) may also be separated from the reaction product by washing said reaction product with a solvent in which the compound of formula (IC) is soluble and the reaction product is not.

In another embodiment, the compounds of formula (IC) may be used as heterogeneous catalyst in a solvent in which they are insoluble. Examples of such solvents are alcohols such as methanol, ethanol, isopropanol and butanol, water or a mixture of these solvents.

In the present invention, the compound of formula (IC) may be in the form of a suspension in the reaction medium. According to another embodiment, the compound of formula (IC) may be deposited on the walls of a reactor in which the organic chemical reaction is implemented, for example by evaporating a solution containing the compound of formula (IC), introduced into a cartridge for a continuous flow reactor or dispersed in an organic or inorganic material.

Advantageously, the present invention relates to the use of a compound of formula (IC) as defined above as a catalyst in a reaction selected from the group consisting of reduction reactions, in particular in the presence of H₂ such as the hydrogenation of carbonyl, alkene, alkyne or arene, the oxidation reactions, particularly in the presence of O₂, the carbon-carbon bond forming reactions such as the Suzuki reaction, Heck, Stille, Kumada and Sonogashira, the carbon-heteroatom bond forming reactions, notably carbon-nitrogen, carbon-oxygen, carbon-phosphorus, and carbon-sulfur bond formation, carbonylation reactions in the presence CO, such as Fischer-Tropsch, the gas phase carboxylation reactions in the presence of CO₂, and asymmetric catalysis reactions such as the epoxide opening reactions or asymmetric catalysis reactions allowing C—C or C—X bond formation.

The present invention therefore relates to the use of a compound of formula (IC) as defined above as a catalyst in an organic chemistry reaction, in particular selected from the group consisting of reduction reactions, in particular in the presence of H₂, such as hydrogenation of carbonyls, alkenes, alkynes and arenes, the oxidation reactions, particularly in the presence of O₂, the carbon-carbon bond forming reactions such as the reaction Suzuki, Heck, Stille, Kumada and Sonogashira, carbon-heteroatom bond forming reactions in particular carbon-nitrogen, carbon-oxygen, carbon-phosphorus, and carbon-sulfur bond formation, carbonylation reactions in the presence of CO, such as Fischer-Tropsch, the gas phase carboxylation reactions in the presence of CO₂, and asymmetric catalysis reactions such as the epoxide opening reactions or the reactions of asymmetric catalysis for C—C or C—X bond formation.

In one embodiment, the present invention relates to the use of a compound of formula (IC) as defined above wherein M is palladium in a carbon-carbon bond forming reaction, in particular in the Heck reaction or Suzuki reaction. Advantageously, using a compound wherein the group Q is a N-heterocyclic carbene, in particular an imidazolylidene. More advantageously, the compound of formula (IC) is a compound of formula (IC1), (IC2) or (IC3), in particular wherein Q is a N-heterocyclic carbene, in particular an imidazolylidene.

In another embodiment, the present invention relates to the use of a compound of formula (IC) as defined above, wherein M is rhodium in a hydrogenation reaction, in particular for hydrogenating a double bond and/or an aromatic ring, in particular an alkene. The selectivity of the rhodium complexes of the present vis-à-vis invention the aromatic ring or the double bond can be controlled by changing the temperature of the reaction. Advantageously, using a compound wherein the group Q is a phosphorus ligand, in particular a phosphine. More advantageously, the compound of formula (IC) is a compound of formula (IC1), (IC2) or (IC3), in particular wherein Q is a phosphorus ligand, in particular a phosphine.

In another embodiment, the present invention relates to the use of a compound of formula (IC) as defined above, wherein M is cobalt in an enantioselective reaction of epoxide opening. Advantageously, using a compound wherein the Q moiety is a salen ligand, in particular in particular enantiopure salen ligands, in particular derivatives of cyclohexyldiamine and diphenylethylene and derivatives of the above salen ligands. In another embodiment, the compounds of formula (IC) can be used as a catalyst wherein the metal leaching ratio of this catalyst is less than 10%, in particular less than 5% of the total weight of the metal content in this catalyst.

A sixth object of the present invention relates to a method for preparing a compound of formula (I) as defined above.

In one embodiment, the present invention relates to a method for preparing a compound of formula (IA) as defined above:

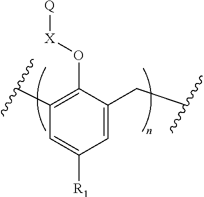

wherein Q is a phosphorus ligand, such as a secondary phosphonite, or a secondary phosphinite other than a phosphine and phosphine oxide,

comprising a step of contacting a compound of formula (II):

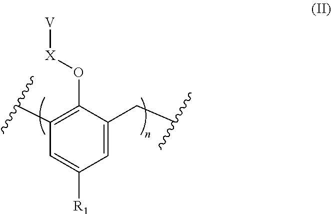

wherein:

n, X, R₁ are as defined above,

V represents a leaving group, in particular chosen from the group consisting of halogens such as Cl, Br and I and sulfonates such as OSO₂Me, OSO₂(C₇H₇) et OSO₂CF₃,

with a compound of formula QA wherein Q is selected from the group consisting of phosphorus ligands, such as a secondary phosphonite, or secondary phosphinite, with the exception of phosphines and phosphine oxides, and A represents an alkali metal selected from the group consisting of Na, K and Li or a is H and the reaction is carried out in the presence of a base.

In this embodiment, the Q group is introduced by a nucleophilic substitution reaction. When X represents a (linear or branched alkyl comprising 1 to 10 carbon atoms)-aryl, the Q group can be introduced on the aryl with a suitable metal catalyst. According to another embodiment, the compound of formula (IA) may be prepared by reacting the calix[n]arene having a free OH group of phenol with a compound of formula Q-XW wherein W represents a leaving group, in particular chosen from the group consisting of halogens such as Cl, Br and I and sulfonates such as OSO₂Me, OSO₂(C₇H₇) et OSO₂CF₃.

In a second embodiment, the present invention relates to a method for preparing a compound of formula (IB) as defined above:

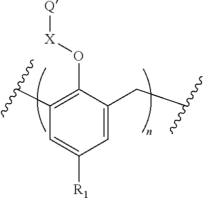

wherein Q is selected from phosphorus ligands with the exception of phosphines and phosphine oxides or chalcogenides, particularly phosphine sulfides, comprising a step of contacting a compound of formula (II):

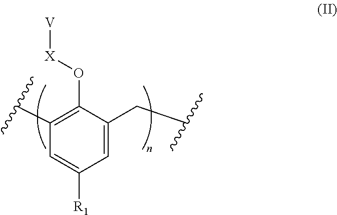

in which:

n, X, R₁ are as defined above,

V represents a leaving group, in particular chosen from the group consisting of halogens such as Cl, Br and I and sulfonates such as OSO₂Me, OSO₂(C₇H₇) and OSO₂CF₃,

with a compound of formula Q′-A wherein Q′ is selected from the group consisting of a phosphorus ligand other than a phosphine and phosphine oxides, a chalcogenide, in particular a secondary phosphine sulfide, secondary phosphinate or secondary phosphonate and A represents an alkali metal selected from the group consisting of Na, K and Li or A is H and the reaction is carried out in the presence of a base.

Potassium salts, sodium and lithium phosphines, phosphinites and phosphonites are known compounds, commercially available.

According to another embodiment, the compound of formula (IB) may be prepared by reacting the calix[n]arene having an OH free phenol group with a compound of formula QXW wherein W represents a leaving group, in particular selected from the group consisting of halogen such as Cl, Br and I and sulfonates such as OSO₂Me, OSO₂(C₇H₇) and OSO₂CF₃.

In a third embodiment, the present invention relates to a method for preparing a compound of formula (IB) as defined above:

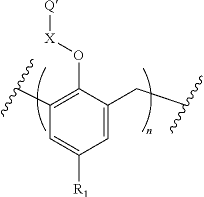

wherein Q′ is selected from the group consisting of azoliums such as 1,3-imidazolium, 1,3-imidazolinium, 1,3-benzimidazolium, 1,2,4-triazolium, 1,3-thiazolium comprising a step of contacting a compound of formula (II):

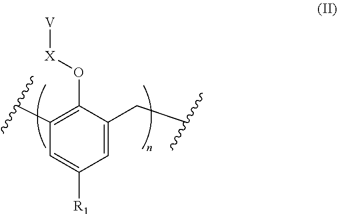

in which:

n, X, R₁ are as defined above,

V represents a leaving group, in particular chosen from the group consisting of halogens such as Cl, Br and I and sulfonates such as OSO₂Me, OSO₂(C₇H₇) and OSO₂CF₃,

with a compound of formula Q′ selected from the group consisting of azoles such as 1,3-imidazoles, 1,3-imidazoline, 1,3-benzimidazoles, 1,2,4-triazoles and 1,3-thiazoles.

The preparation of compounds of formula (IB) wherein the moiety Q is an azolium may be embodied in other methodologies well known to the skilled person. This is for example a method wherein a compound of formula (II) wherein V represents an azole is alkylated with an alkylating agent such as an alkyl halide. According to another embodiment, the compound of formula (IB) may be prepared by reacting the calix[n]arene having a free OH group of phenol with a compound of formula Q′-XW wherein W represents a leaving group, in particular selected from the group consisting of halogens such as Cl, Br and I and sulfonates such as OSO₂Me, OSO₂(C₇H₇) and OSO₂CF₃.

In a fourth embodiment, the present invention relates to a method for preparing a metal complex as defined above, in particular a compound of formula (IC).

Methods for the preparation of compounds of formula (IC) differ depending on the metal precursor used and the nature of the ligand. The skilled person will know, on the basis of this patent application, prepare the corresponding metal complexes.

The present invention therefore relates in one embodiment to a method for preparing a compound of formula (IC) as defined above:

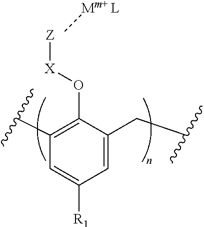

in which:

n, X, L, M^{m+} and R₁ are as defined above,

Z represents a group Q selected from the group consisting of phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

comprising a step of contacting a compound of formula I wherein t is 0 and Z represents a group Q selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

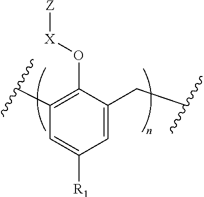

with a metal complex of formula (L′)M^{m+} where M^{m+} is a metal in oxidation state m or a metal cluster comprising a plurality of metals in the oxidation state m, where m is 0, 1, 2, 3, 4 or 5, in particular 0, 1, 2 or 3, and L′ is comprised of one or more neutral or negatively charged ligands bound to the metal.

The metal precursors used for the preparation of metal complexes, in particular of formula (IC) are for example in the case of rhodium alkene rhodium complexes such as [(norbornadiene)RhCl]₂, [(cyclooctadiene)RhCl]₂ or salts such as RhCl₃, in the case of palladium PdCl₂, (cyclooctadiene)PdCl₂, palladium complexes and dibenzylidenacetone such as Pd(dba)₂ and Pd₂(dba)₃, Pd(CH₃CN)₂Cl₂ or in the case of Cobalt COCl₂ or Co(OAc)₂.

The metal precursors used for the preparation of compounds of formula (IC) are well known to those skilled in the art will be able to select the precursor and appropriate reaction conditions to obtain the desired complex.

The compounds of formula (IC) wherein Q is an azolylidene can be prepared according to various methodologies known to the skilled person. When the metal precursor contains no ligand may lead to the formation of N-heterocyclic carbene (such as a basic ligand) can be prepared N-heterocyclic carbene or before preparing a complex for use in a transmetalation reaction (e.g., a complex with silver). The complex may also be prepared by in situ carbene generation, ie by reaction with a metal precursor containing a ligand capable of generating the carbene or in the presence of a base. In another embodiment, the present invention relates to a method for preparing a compound of preparing a compound of formula (IC) as defined above:

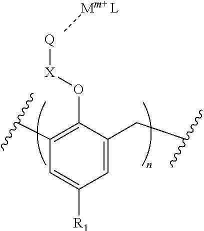

in which:

n, X, L, M^{m+} and R₁ are as defined above,

comprising a step of contacting a compound of formula (IB)

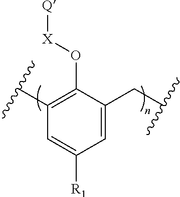

as defined above, wherein Q′ is selected from the group consisting of azoliums such as 1,3-imidazolium, 1,3-imidazolinium, 1,3-benzimidazolium, 1,2,4-triazolium and 1,3-thiazolium,

with a metal complex of formula (L′)M^{m+} where M^{m+} is a metal in oxidation state m, where m is 0, 1, 2, 3, 4 or 5, in particular 0, 1, 2 or 3, and L′ is comprised of one or more neutral or negatively charged ligands bound to the metal, optionally in the presence of a base. The present invention also relates to another method of preparation a compound of formula (IC) as defined above:

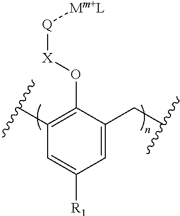

in which:

n, X, L, M^{m+} and R₁ are as defined above,

comprising the steps of:

(a) contacting a compound of formula (IB):

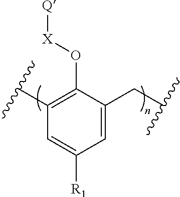

as defined above, wherein Q′ is selected from the group consisting of azoliums such as 1,3-imidazolium, 1,3-imidazolinium, 1,3-benzimidazolium, 1,2,4-triazolium, the 1,3-thiazolium with a base, to give a N-heterocyclic carbene, such as a 1,3-imidazolylidene, a 1,3-imidazolinylidene, a 1,2,4-triazolylidene, a 1,3-benzimidazolylidene, a 1,2,4-triazolylidene or a 1,3-thiazolylidene of formula (IA) as defined above, (b) contacting the N-heterocyclic carbene obtained in step (a) with a metal complex of formula (L′)M^{m+} where M^{m+} is a metal in oxidation state m or a metal cluster comprising a plurality of metals in the oxidation state m, where m is 0, 1, 2, 3, 4 or 5 in particular 0, 1, 2 or 3, and L′ is comprised of one or more neutral or negatively charged ligands bound to the metal to give the compound of formula (IC).

A seventh object of the present invention is a compound of formula (IV):

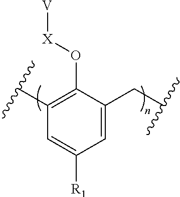

in which:

n and R₁ are as defined above,

X is a linear or branched alkyl containing from 4 to 8 carbon atoms, in particular 4 carbon atoms,

V represents a leaving group, in particular chosen from the group consisting of halogens such as Cl, Br and I and sulfonates such as SO₃Me, SO₃(C₇H₇) and SO₃CF₃.

An eighth object of the present invention is a method for preparing a compound of formula (IV) as defined above:

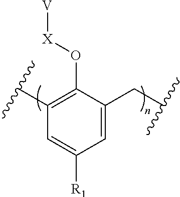

comprising a nucleophilic substitution reaction involving a compound of general formula

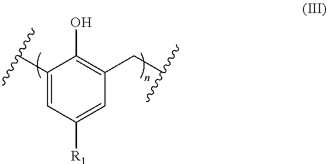

and a group precursor of general formula —X—V, wherein X and V are as defined above, such as alkyl dihalides, preferably the 1-bromo-4-chlorobutane,

in the presence of a base, preferably sodium or potassium carbonate, hydride, and a solvent, preferably dimethylformamide (DMF) to give the compound of general formula (IV):

wherein R₁ and n are as defined above, n is preferably 7 to 20, in particular 8.

This methodology provides the calix[n]arena with a 90% efficiency (against 51% in the prior art).

Advantageously, said compound of formula (IV) is isolated by at least a pulping step in an alcohol, preferably methanol or ethanol, in the absence of another solvent. In an advantageous embodiment, the compound of formula (V) is isolated by a first trituration with methanol and a second trituration with ethanol.

Using this methodology, the product of formula (IV) is obtained in almost pure, that is to say a degree of purity greater than 95%, without chromatography step. The present invention further relates to a method for preparing a compound of formula (IA) as defined above:

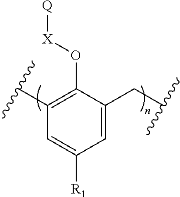

wherein Q is a phosphorus ligand such as a secondary phosphinite or secondary phosphonite, with the exception of a phosphine and phosphine oxide,

or

for preparing a compound of formula (IB) as defined above:

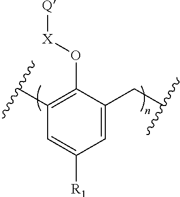

wherein Q′ is selected from the group consisting of azoliums such as 1,3-imidazolium, 1,3-imidazolinium, 1,3-benzimidazolium, 1,2,4-triazolium, 1,3-thiazolium comprising a step of contacting a compound of formula (II):

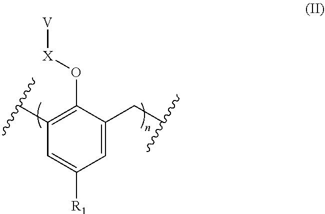

in which:

n, X, R₁ are as defined above,

V represents a leaving group, in particular chosen from the group consisting of halogens such as Cl, Br and I and sulfonates such as OSO₂Me, OSO₂(C₇H₇) and OSO₂CF₃,

with a compound of formula QA wherein Q is selected from the group consisting of phosphorus ligands such as a secondary phosphonite, or secondary, with the exception of phosphines and phosphine oxides and A represents an alkali metal selected from the group consisting of Na, K and Li or a is H and the reaction is carried out in the presence of a base, to give a compound of formula (IA),

or with a compound of formula Q′ selected from the group consisting of azoles such as 1,3-imidazoles, 1,3-imidazoline, 1,3-benzimidazoles, 1,2,4-triazoles and 1,3-thiazoles.

The present invention further relates to a method for preparing a compound of formula (IC):

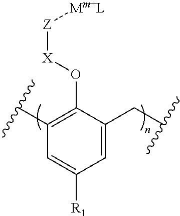

in which:

n, X, L, M^{m+} and R₁ are as defined above,

Z represents a group Q selected from the group consisting of phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes,

comprising a step of contacting a compound of formula I wherein t is 0 and Z represents a group Q selected from the group consisting of phosphorus ligands such as phosphines, phosphonites, phosphinites, and N-heterocyclic carbenes such as 1,3-imidazolylidenes, 1,3-imidazolinylidenes, 1,2,4-triazolylidenes, 1,3-benzimidazolylidenes, 1,2,4-triazolylidenes and 1,3-thiazolylidenes,

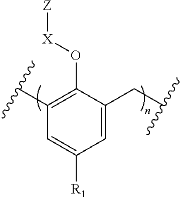

with a metal complex of formula (L′)M^{m+} where M^{m+} is a metal in oxidation state m or a metal cluster comprising a plurality of metals in the oxidation state m, where m is 0, 1, 2, 3, 4 or 5, in particular 0, 1, 2 or 3, and L′ is comprised of 0, one or more neutral or negatively charged ligands bound to the metal.

In one embodiment, the present invention relates to a method for preparing a compound of formula (IA) as defined above:

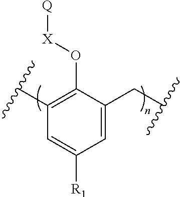

in which:

n, X, R₁ are as defined above,

Q is selected from the group consisting of salen ligands, in particular enantiopure salen ligands, in particular derivatives of cyclohexyldiamine and diphenylethylene and derivatives of the above salen ligands,

comprising a step of contacting a compound of formula (IB):

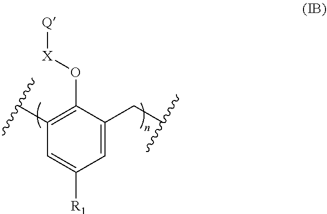

in which:

n, X, R₁ are as defined above,

Q′ represents a group precursor of the salen ligand, in particular derivatives of salicylaldehyde and in particular the 3-(tert-butyl)-5-triazol-2-hydroxybenzaldehyde,

with another precursor group of the salen ligand, in particular salicylaldehyde derivatives and in particular the compound of formula VII.

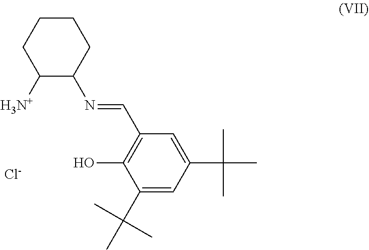 [SMILES: [Cl-] ; CC(C)(C)c1cc(/C=N/C2CCCCC2[NH3+])c(O)c(C(C)(C)C)c1]

In one embodiment, the present invention relates to a method for preparing a compound of formula (IB) as defined above:

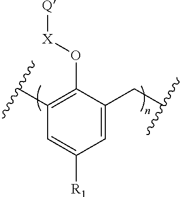

wherein Q′ is selected from the salen ligand precursor group, in particular salicylaldehyde derivatives in particular 3-(tert-butyl)-5-triazol-2-hydroxybenzaldehyde, comprising a step of contacting a compound of formula (VIII):

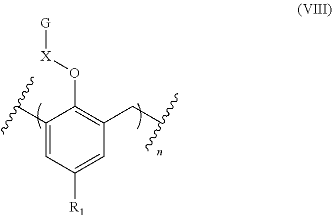

in which:

n, X, R₁ are as defined above,

G represents a grafting group of the group Q′, in particular an N₃ group, with the group Q′ selected from the salen ligand precursor group, in particular derivatives of salicylaldehyde and in particular the 3-(tert-butyl)-5 ethynyl-2-hydroxybenzaldehyde.

In one embodiment, the present invention relates to a method for preparing a compound of formula (VIII) as defined above:

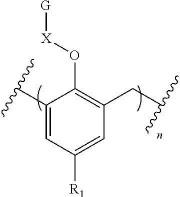

wherein G is selected as above,

comprising a step of contacting a compound of formula (II):

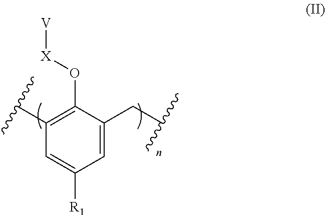

in which:

n, X, R₁ are as defined above,

V represents a leaving group, in particular chosen from the group consisting of halogens such as Cl, Br and I and sulfonates such as OSO₂Me, OSO₂(C₇H₇) et OSO₂CF₃,

with a precursor of a grafting group of the group Q′, in particular sodium azide, with Q′ as defined above.

In another embodiment, the present invention relates to a method for preparing a compound of preparing a compound of formula (IC) as defined above:

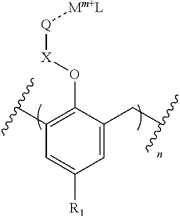

in which:

n, X, L, M^{m+} and R₁ are as defined above,

wherein Q is selected from the group consisting of salen ligands, in particular enantiopure salen ligands, in particular derivatives of cyclohexyldiamine and diphenylethylene and derivatives of the above salen ligands

comprising a step of contacting a compound of formula (IA):

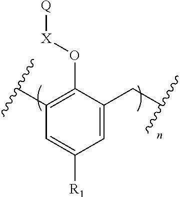

wherein Q is selected from the group consisting of salen ligands, in particular enantiopure salen ligands, in particular derivatives of cyclohexyldiamine and diphenylethylene and derivatives of the above salen ligands,

with a metal complex of formula LM^{m+}, wherein M^{m+} is a metal in oxidation state m, where m is 0, 1, 2, 3, 4 or 5, in particular 0, 1, 2 or 3, and L consists one or more neutral ligands or negatively charged linked to the metal, optionally in the presence of a base, in particular with cobalt acetate and paratoluenesulfonic acid.

In one embodiment, the present invention relates to a method for preparing a compound of formula (IC) as defined above:

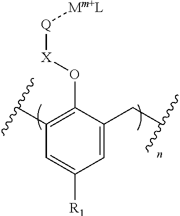

in which:

n, X, L, M^{m+} and R₁ are as defined above,

and Q is selected from the group consisting of salen ligands, in particular enantiopure salen ligands, in particular derivatives of cyclohexyldiamine and diphenylethylene and derivatives of the above salen ligands,

comprising a step of contacting a compound of formula (II):

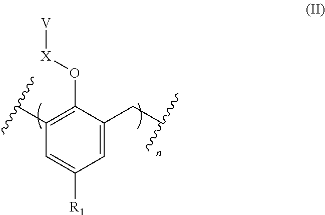

in which:

n, X, R₁ are as defined above,

V represents a leaving group, in particular chosen from the group consisting of halogens such as Cl, Br and I and sulfonates such as OSO₂Me, OSO₂(C₇H₇) et OSO₂CF₃,

with a precursor of a grafting group of the group Q′, particularly sodium azide,

Q′ represents a group selected from the salen ligand precursor group, in particular derivatives of salicylaldehyde and in particular the 3-(tert-butyl)-5-triazol-2-hydroxybenzaldehyde,

to obtain a compound of formula (VIII)

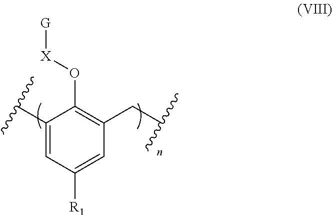

in which:

n, X, R₁ are as defined above,

G represents a group of said grafting group of the group Q, in particular a N₃ group, and comprising a step of contacting said compound of formula (VIII) with to give a compound of formula (IB)

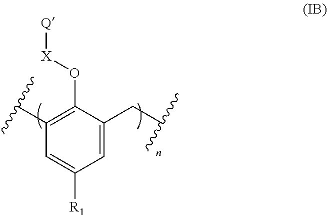

in which:

n, X, R and Q′ are as defined above, then comprising a step of contacting said compound of formula (IB),

with another precursor group of the salen ligand, in particular derivatives of salicylaldehyde and in particular the compound of formula (VII),

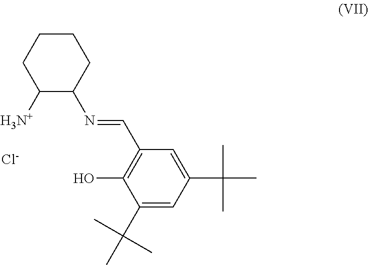 [SMILES: [Cl-] ; CC(C)(C)c1cc(/C=N/C2CCCCC2[NH3+])c(O)c(C(C)(C)C)c1]

to obtain a compound of formula (IA),

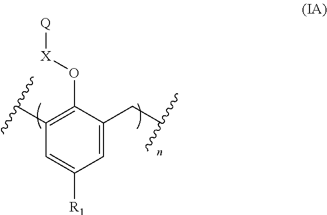

in which:

n, X, R and Q are as defined above,

and comprising a step of contacting a compound of formula (IA),

with a metal complex of formula LM^{m+}, wherein M^{m+} is a metal in oxidation state m, where m is 0, 1, 2, 3, 4 or 5, in particular 0, 1, 2 or 3 and L consists of one or more neutral ligands or negatively charged linked to the metal, optionally in the presence of a base, in particular with cobalt acetate and para-toluenesulfonic acid,

to obtain said compound of formula (IC).

The present invention relates, in particular embodiments, the following compounds:

| n | R₁ | X | L | L′ |
|---|---|---|---|---|
| 8 | OCH₂Ph | —(CH₂)₃— | Phosphine | — |
| 8 | OCH₂Ph | —(CH₂)₄— | Phosphine | — |
| 8 | OCH₂Ph | —(CH₂)₅— | Phosphine | — |
| 8 | OCH₂Ph | —(CH₂)₆— | Phosphine | — |
| 8 | OCH₂Ph | —(CH₂)₇— | Phosphine | — |
| 8 | OCH₂Ph | —(CH₂)₈— | Phosphine | — |
| 8 | OCH₂Ph | —(CH₂)₃— | NHC | — |
| 8 | OCH₂Ph | —(CH₂)₄— | NHC | — |
| 8 | OCH₂Ph | —(CH₂)₅— | NHC | — |
| 8 | OCH₂Ph | —(CH₂)₆— | NHC | — |
| 8 | OCH₂Ph | —(CH₂)₇— | NHC | — |
| 8 | OCH₂Ph | —(CH₂)₈— | NHC | — |
| 8 | OCH₂Ph | —(CH₂)₃— | — | Azolium |
| 8 | OCH₂Ph | —(CH₂)₄— | — | Azolium |
| 8 | OCH₂Ph | —(CH₂)₅— | — | Azolium |
| 8 | OCH₂Ph | —(CH₂)₆— | — | Azolium |
| 8 | OCH₂Ph | —(CH₂)₇— | — | Azolium |
| 8 | OCH₂Ph | —(CH₂)₈— | — | Azolium |
| 8 | t-Bu | —(CH₂)₃— | Phosphine | |
| 8 | t-Bu | —(CH₂)₄— | Phosphine | |
| 8 | t-Bu | —(CH₂)₅— | Phosphine | |
| 8 | t-Bu | —(CH₂)₆— | Phosphine | |
| 8 | t-Bu | —(CH₂)₇— | Phosphine | |
| 8 | t-Bu | —(CH₂)₈— | Phosphine | |
| 8 | t-Bu | —(CH₂)₃— | NHC | |
| 8 | t-Bu | —(CH₂)₄— | NHC | |
| 8 | t-Bu | —(CH₂)₅— | NHC | |
| 8 | t-Bu | —(CH₂)₆— | NHC | |
| 8 | t-Bu | —(CH₂)₇— | NHC | |
| 8 | t-Bu | —(CH₂)₈— | NHC | |
| 8 | t-Bu | —(CH₂)₃— | — | Azolium |
| 8 | t-Bu | —(CH₂)₄— | — | Azolium |
| 8 | t-Bu | —(CH₂)₅— | — | Azolium |
| 8 | t-Bu | —(CH₂)₆— | — | Azolium |
| 8 | t-Bu | —(CH₂)₇— | — | Azolium |
| 8 | t-Bu | —(CH₂)₈— | — | Azolium |
| 8 | n-octyl | —(CH₂)₃— | Phosphine | — |
| 8 | n-octyl | —(CH₂)₄— | Phosphine | — |
| 8 | n-octyl | —(CH₂)₅— | Phosphine | — |
| 8 | n-octyl | —(CH₂)₆— | Phosphine | — |
| 8 | n-octyl | —(CH₂)₇— | Phosphine | — |
| 8 | n-octyl | —(CH₂)₈— | Phosphine | — |
| 8 | n-octyl | —(CH₂)₃— | NHC | — |
| 8 | n-octyl | —(CH₂)₄— | NHC | — |
| 8 | n-octyl | —(CH₂)₅— | NHC | — |
| 8 | n-octyl | —(CH₂)₆— | NHC | — |
| 8 | n-octyl | —(CH₂)₇— | NHC | — |
| 8 | n-octyl | —(CH₂)₈— | NHC | — |
| 8 | n-octyl | —(CH₂)₃— | — | Azolium |
| 8 | n-octyl | —(CH₂)₄— | — | Azolium |
| 8 | n-octyl | —(CH₂)₅— | — | Azolium |
| 8 | n-octyl | —(CH₂)₆— | — | Azolium |
| 8 | n-octyl | —(CH₂)₇— | — | Azolium |
| 8 | n-octyl | —(CH₂)₈— | — | Azolium |
| 16 | OCH₂Ph | —(CH₂)₃— | Phosphine | — |
| 16 | OCH₂Ph | —(CH₂)₄— | Phosphine | — |
| 16 | OCH₂Ph | —(CH₂)₅— | Phosphine | — |
| 16 | OCH₂Ph | —(CH₂)₆— | Phosphine | — |
| 16 | OCH₂Ph | —(CH₂)₇— | Phosphine | — |
| 16 | OCH₂Ph | —(CH₂)₈— | Phosphine | — |
| 16 | OCH₂Ph | —(CH₂)₃— | NHC | — |
| 16 | OCH₂Ph | —(CH₂)₄— | NHC | — |
| 16 | OCH₂Ph | —(CH₂)₅— | NHC | — |
| 16 | OCH₂Ph | —(CH₂)₆— | NHC | — |
| 16 | OCH₂Ph | —(CH₂)₇— | NHC | — |
| 16 | OCH₂Ph | —(CH₂)₈— | NHC | — |
| 16 | OCH₂Ph | —(CH₂)₃— | — | Azolium |
| 16 | OCH₂Ph | —(CH₂)₄— | — | Azolium |
| 16 | OCH₂Ph | —(CH₂)₅— | — | Azolium |
| 16 | OCH₂Ph | —(CH₂)₆— | — | Azolium |
| 16 | OCH₂Ph | —(CH₂)₇— | — | Azolium |
| 16 | OCH₂Ph | —(CH₂)₈— | — | Azolium |
| 16 | t-Bu | —(CH₂)₃— | Phosphine | |
| 16 | t-Bu | —(CH₂)₄— | Phosphine | |
| 16 | t-Bu | —(CH₂)₅— | Phosphine | |
| 16 | t-Bu | —(CH₂)₆— | Phosphine | |
| 16 | t-Bu | —(CH₂)₇— | Phosphine | |
| 16 | t-Bu | —(CH₂)₈— | Phosphine | |
| 16 | t-Bu | —(CH₂)₃— | NHC | |
| 16 | t-Bu | —(CH₂)₄— | NHC | |
| 16 | t-Bu | —(CH₂)₅— | NHC | |
| 16 | t-Bu | —(CH₂)₆— | NHC | |
| 16 | t-Bu | —(CH₂)₇— | NHC | |
| 16 | t-Bu | —(CH₂)₈— | NHC | |
| 16 | t-Bu | —(CH₂)₃— | — | Azolium |
| 16 | t-Bu | —(CH₂)₄— | — | Azolium |
| 16 | t-Bu | —(CH₂)₅— | — | Azolium |
| 16 | t-Bu | —(CH₂)₆— | — | Azolium |
| 16 | t-Bu | —(CH₂)₇— | — | Azolium |
| 16 | t-Bu | —(CH₂)₈— | — | Azolium |
| 16 | n-octyl | —(CH₂)₃— | Phosphine | — |
| 16 | n-octyl | —(CH₂)₄— | Phosphine | — |
| 16 | n-octyl | —(CH₂)₅— | Phosphine | — |
| 16 | n-octyl | —(CH₂)₆— | Phosphine | — |
| 16 | n-octyl | —(CH₂)₇— | Phosphine | — |
| 16 | n-octyl | —(CH₂)₈— | Phosphine | — |
| 16 | n-octyl | —(CH₂)₃— | NHC | — |
| 16 | n-octyl | —(CH₂)₄— | NHC | — |
| 16 | n-octyl | —(CH₂)₅— | NHC | — |
| 16 | n-octyl | —(CH₂)₆— | NHC | — |
| 16 | n-octyl | —(CH₂)₇— | NHC | — |
| 16 | n-octyl | —(CH₂)₈— | NHC | — |
| 16 | n-octyl | —(CH₂)₃— | — | Azolium |
| 16 | n-octyl | —(CH₂)₄— | — | Azolium |
| 16 | n-octyl | —(CH₂)₅— | — | Azolium |
| 16 | n-octyl | —(CH₂)₆— | — | Azolium |
| 16 | n-octyl | —(CH₂)₇— | — | Azolium |
| 16 | n-octyl | —(CH₂)₈— | — | Azolium |
| 35 | OCH₂Ph | —(CH₂)₃— | Phosphine | — |
| 35 | OCH₂Ph | —(CH₂)₄— | Phosphine | — |
| 35 | OCH₂Ph | —(CH₂)₅— | Phosphine | — |
| 35 | OCH₂Ph | —(CH₂)₆— | Phosphine | — |
| 35 | OCH₂Ph | —(CH₂)₇— | Phosphine | — |
| 35 | OCH₂Ph | —(CH₂)₈— | Phosphine | — |
| 35 | OCH₂Ph | —(CH₂)₃— | NHC | — |
| 35 | OCH₂Ph | —(CH₂)₄— | NHC | — |
| 35 | OCH₂Ph | —(CH₂)₅— | NHC | — |
| 35 | OCH₂Ph | —(CH₂)₆— | NHC | — |
| 35 | OCH₂Ph | —(CH₂)₇— | NHC | — |
| 35 | OCH₂Ph | —(CH₂)₈— | NHC | — |
| 35 | OCH₂Ph | —(CH₂)₃— | — | Azolium |
| 35 | OCH₂Ph | —(CH₂)₄— | — | Azolium |
| 35 | OCH₂Ph | —(CH₂)₅— | — | Azolium |
| 35 | OCH₂Ph | —(CH₂)₆— | — | Azolium |
| 35 | OCH₂Ph | —(CH₂)₇— | — | Azolium |
| 35 | OCH₂Ph | —(CH₂)₈— | — | Azolium |
| 35 | t-Bu | —(CH₂)₃— | Phosphine | |
| 35 | t-Bu | —(CH₂)₄— | Phosphine | |
| 35 | t-Bu | —(CH₂)₅— | Phosphine | |
| 35 | t-Bu | —(CH₂)₆— | Phosphine | |
| 35 | t-Bu | —(CH₂)₇— | Phosphine | |
| 35 | t-Bu | —(CH₂)₈— | Phosphine | |
| 35 | t-Bu | —(CH₂)₃— | NHC | |
| 35 | t-Bu | —(CH₂)₄— | NHC | |
| 35 | t-Bu | —(CH₂)₅— | NHC | |
| 35 | t-Bu | —(CH₂)₆— | NHC | |
| 35 | t-Bu | —(CH₂)₇— | NHC | |
| 35 | t-Bu | —(CH₂)₈— | NHC | |
| 35 | t-Bu | —(CH₂)₃— | — | Azolium |
| 35 | t-Bu | —(CH₂)₄— | — | Azolium |
| 35 | t-Bu | —(CH₂)₅— | — | Azolium |
| 35 | t-Bu | —(CH₂)₆— | — | Azolium |
| 35 | t-Bu | —(CH₂)₇— | — | Azolium |
| 35 | t-Bu | —(CH₂)₈— | — | Azolium |
| 35 | n-octyl | —(CH₂)₃— | Phosphine | — |
| 35 | n-octyl | —(CH₂)₄— | Phosphine | — |
| 35 | n-octyl | —(CH₂)₅— | Phosphine | — |
| 35 | n-octyl | —(CH₂)₆— | Phosphine | — |
| 35 | n-octyl | —(CH₂)₇— | Phosphine | — |
| 35 | n-octyl | —(CH₂)₈— | Phosphine | — |
| 35 | n-octyl | —(CH₂)₃— | NHC | — |
| 35 | n-octyl | —(CH₂)₄— | NHC | — |
| 35 | n-octyl | —(CH₂)₅— | NHC | — |
| 35 | n-octyl | —(CH₂)₆— | NHC | — |
| 35 | n-octyl | —(CH₂)₇— | NHC | — |
| 35 | n-octyl | —(CH₂)₈— | NHC | — |
| 35 | n-octyl | —(CH₂)₃— | — | Azolium |
| 35 | n-octyl | —(CH₂)₄— | — | Azolium |
| 35 | n-octyl | —(CH₂)₅— | — | Azolium |
| 35 | n-octyl | —(CH₂)₆— | — | Azolium |
| 35 | n-octyl | —(CH₂)₇— | — | Azolium |
| 35 | n-octyl | —(CH₂)₈— | — | Azolium |
| 8 | OCH₂Ph | —(CH₂)₄— | salen Ligand | |
| 8 | OCH₂Ph | —(CH₂)₄— | | Salicylaldéhyde |

### EXAMPLES

The four schemes below illustrate the synthesis of the catalysts according to the present invention containing a N-heterocyclic carbene or phosphine:

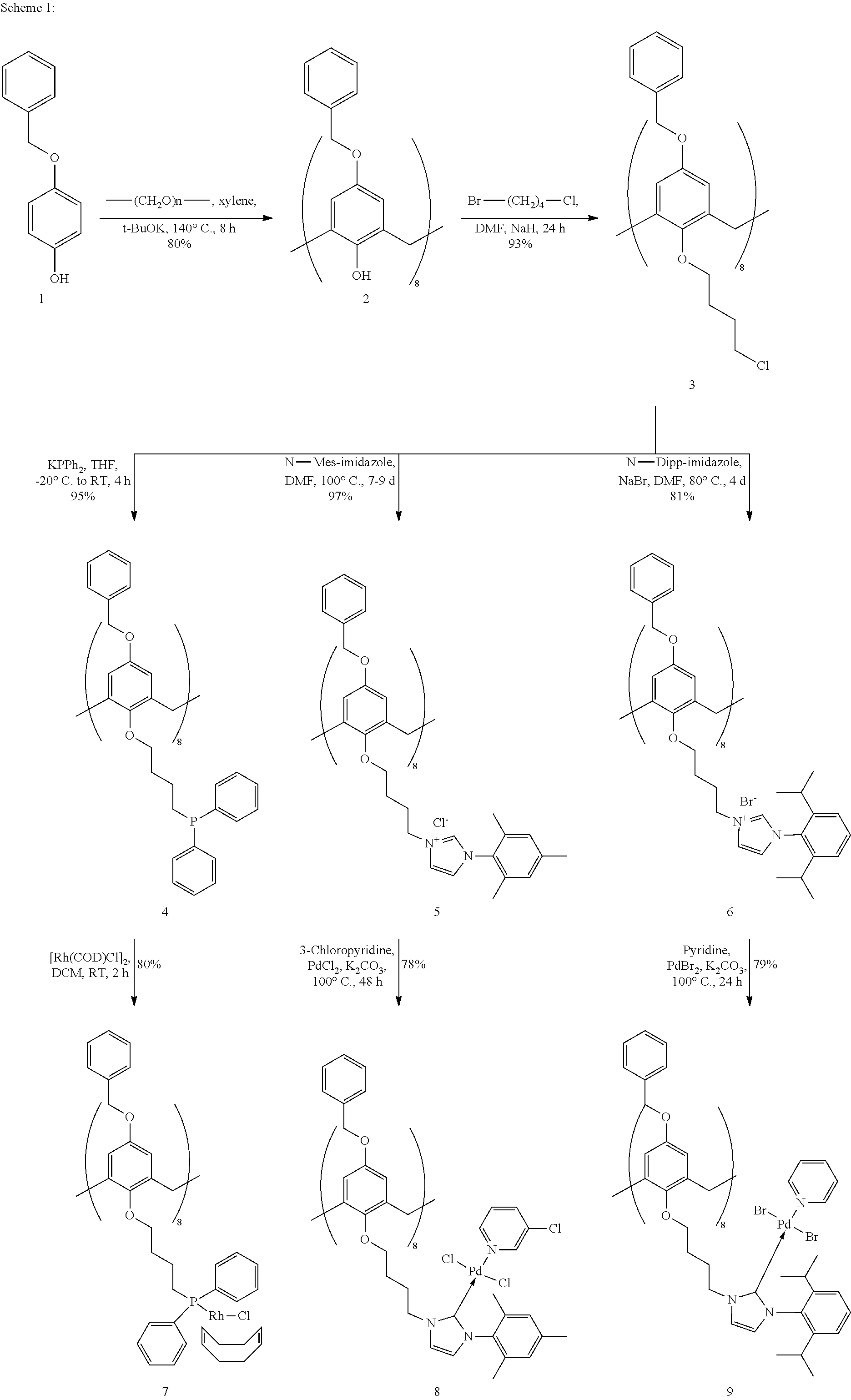

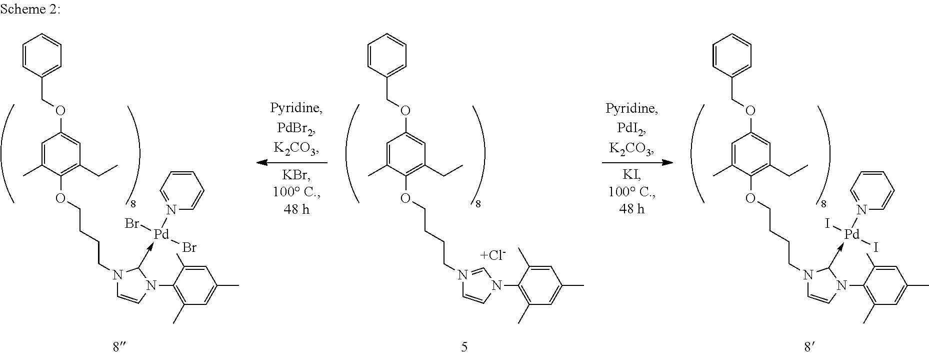

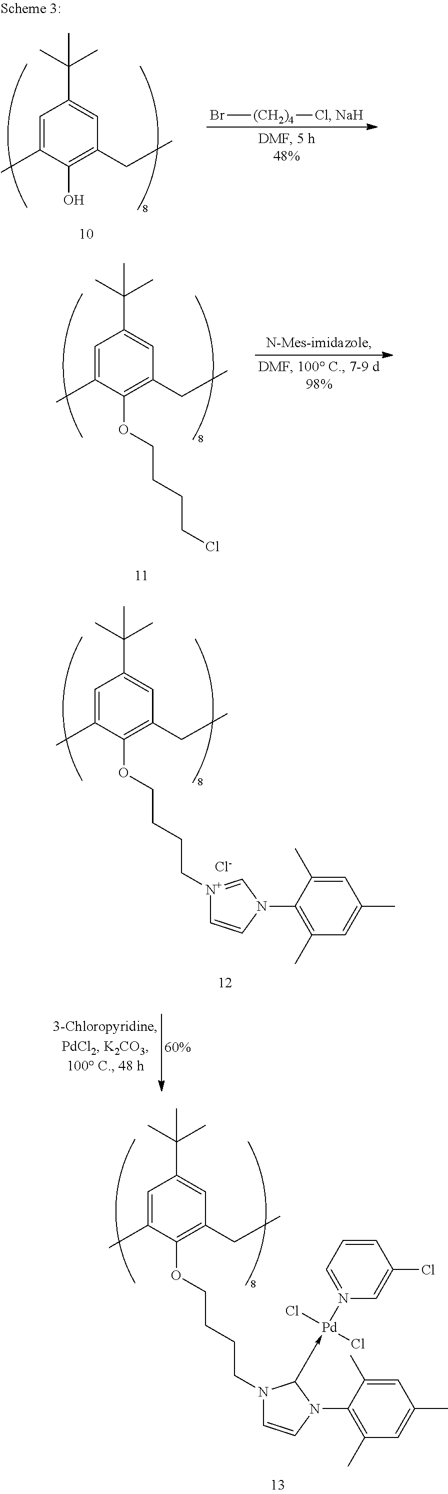

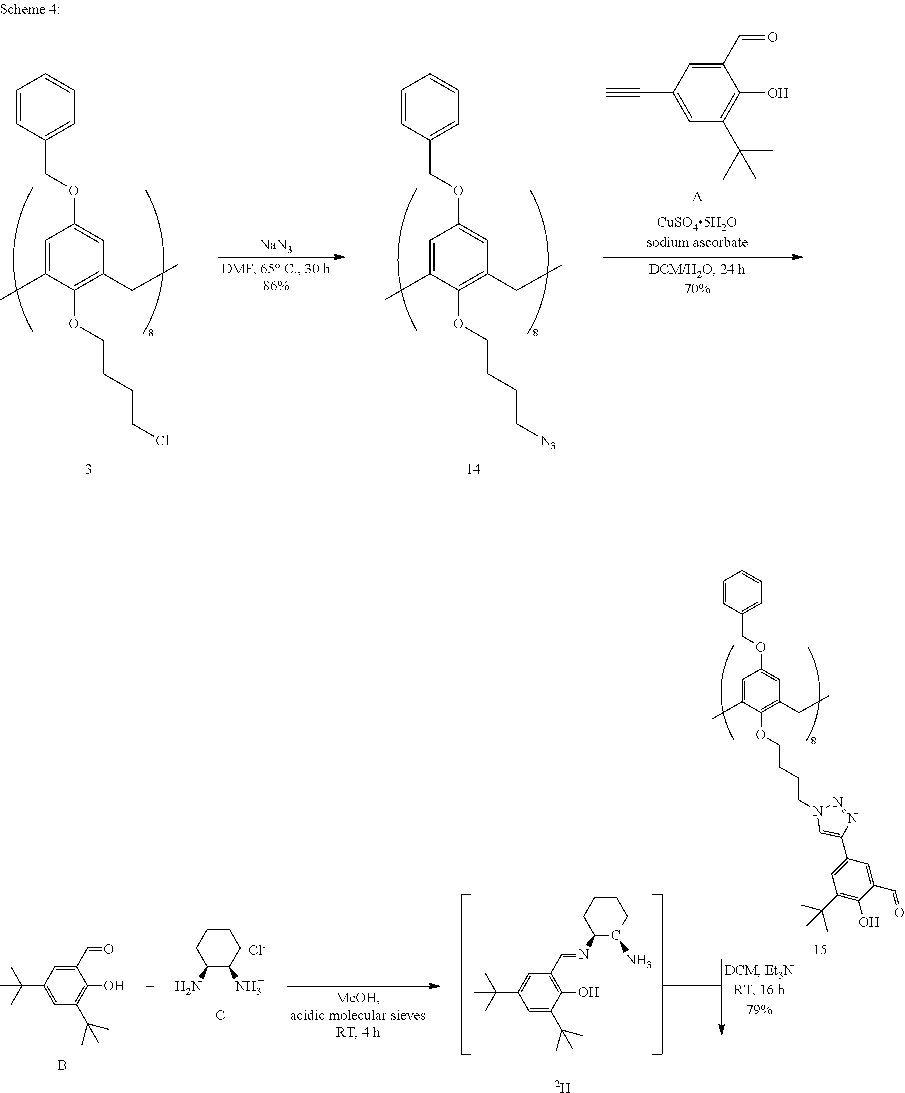

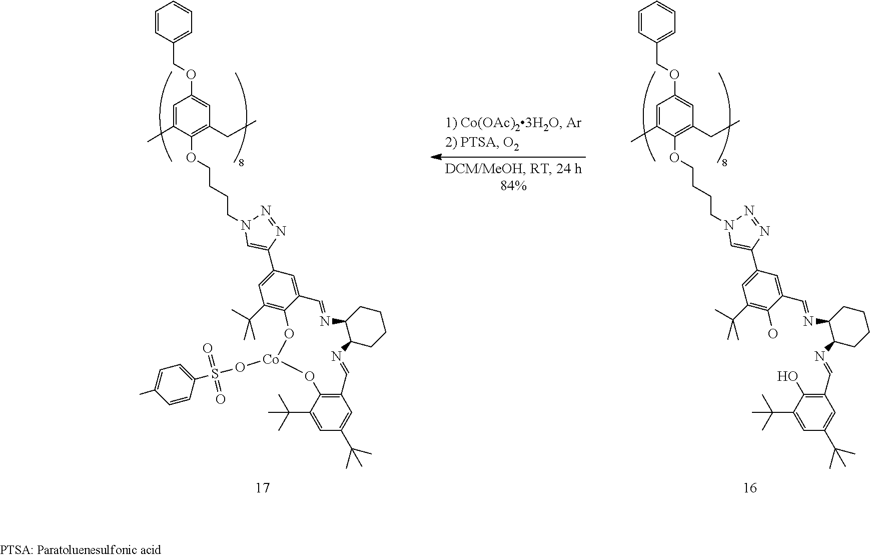

### Example 1: Preparation of the Chlorinated Precursors

### Preparation of Calixarene 2

Benzyloxyphenol 1 (200 g, 1 mol), paraformaldehyde (78.7 g) and xylene (2 L) were loaded, and the medium was placed under argon. t-BuOK (7.39 g, 65.9 mmol) was loaded and vacuum-argon cycles were performed. The mixture was brought to reflux for 8 hours under strong stirring, collecting the water formed with a Dean-Stark water separating apparatus. The mixture was allowed to cool to room temperature and the xylene was evaporated under reduced pressure. The solid residue was heated at 45° C. in 3 L of THF under vigorous stirring, filtered and rinsed with 500 ml of THF. The cake was dispersed with vigorous stirring in 2.5 L of THF at 45° C. for 30 min. 1 L of THF was evaporated and a solution of THF/HCl (33%) (200/50 ml) was added. The mixture was stirred for 30 min at room temperature, filtered and rinsed with 250 ml of THF. The product was allowed to dry overnight under air and then a few hours using a rotary vane pump, after grinding. 169.5 g of very pure product was obtained (yield: 80%). ¹H NMR (DMSO-d6, ppm): 8.67 (s, 8H), 7.30 (m, 40H), 6.58 (s, 16H), 4.80 (s, 16H); 3.77 (s, 16H). m/z (MALDI, matrice DHB): 1719.62 [M+Na⁺] (calc=1697.67).

### Preparation of Calixarene 3

Ground benzyloxycalix[8]arene 2 (60 g, 35.3 mmol) was loaded, then, 1-bromo-4-chlorobutane (520 ml, 3 mol) and DMF (90 ml) were added under argon. The mixture was heated to 40° C., stirring was stopped and a third of the sodium hydride (22.6 g, 5.65.10⁻¹ mol) was added. The mixture was placed under argon and stirring was gradually started. The rest of the sodium hydride was added in two fractions, spacing each addition by 1 h30. The mixture was allowed to react at 30° C. until the next morning. 350 ml of dichloromethane was added, the mixture was filtered over Celite, rinsed with 200 ml of dichloromethane and the solvents are evaporated at 60° C. under reduced pressure. 2 L of methanol was added and the solid was dispersed with vigorous stirring for 24 hours. The mixture was filtered, and the cake was dried several hours in air and then to the vane pump. 2 L of ethanol is added and the solid is dispersed with vigorous stirring for 24 hours. The mixture was filtered, and the cake was dried several hours in air and then using a rotary vane pump. 80 g of a pure white solid was obtained (yield=93%). ¹H NMR (DMSO-d6, ppm): 7.15 (m, 40H), 6.51 (s, 16H), 4.69 (s, 16H), 3.89 (s, 16H), 3.56 (m, 16H), 3.47 (t, 16H, ³J(H,H)=6.4 Hz), 1.75 (m, 16H), 1.65 (m, 16H). ¹³C NMR (DMSO-d6, ppm): 155.17, 149.83, 138.08, 135.67, 129.34, 128.74, 128.64, 115.75, 73.38, 70.26, 46.29, 30.91, 30.20, 28.35. m/z (ESI, DCM-isopropanol, positive mode): 2439.85 [M+Na⁺].

### Example 2: Preparation of Phosphorus Ligands

### Phosphorus Ligand 4

Calixarene 3 (10 g, 4.13 mmol) was loaded in a reactor, dried under vacuum for 30 min, followed by addition of THF (17 ml) under argon. The solution was cooled to −20° C. and a solution of KPPh₂ (70.2 ml, 0.5 M in THF, 35.1 mmol) was slowly added. The solution was stirred at room temperature for 4 h, followed by addition of DCM (20 ml). The mixture was filtered through celite and rinsed with DCM. The filtrate is evaporated to dryness and the residue was triturated with diethyl ether and filtered. The cake was triturated with pentane and filtered. The product was dried under vacuum and to obtain 14.2 g of a pale yellow product (yield: 95%). ¹H NMR (CDCl₃, ppm): 7.39 to 7.33 (m, 40H), 7.26 to 7.23 (m, 40H), 7.00 (s, 30H), 6.45 (s, 16H), 4.43 (s, 16H), 3.88 (s, 16H), 3.60 (m, 16H), 2.09 to 1.97 (m, 16H), 1, 78 (m, 16H), 1, 57 (m, 16H). ³¹P NMR (CDCl₃, ppm): −16.33 (s).

### Example 3: Preparation of Imidazolium Salts (Precursors of Heterocyclic N-Carbene Ligands)

### Ligand IMes.HCl 5

Calixarene 3 (10.1 g, 4.2 mmol) and mesitylimidazole (25 g, 134.2 mmol) were loaded. The reactor was placed under an argon atmosphere and then anhydrous DMF was added (200 ml). 3 vacuum/argon were performed, and the mixture was heated for 7-9 days at 100° C. with stirring (the reaction was monitored by NMR). DMF was evaporated and the product is dissolved in DCM (200 ml) and precipitated with ether (300 ml). The resulting brown solid was washed with diethyl ether (300 ml), triturated with diethyl ether (100 ml) and filtered. 15.5 g of a brown solid were obtained (yield=97%). ¹H NMR (DMSO-d6, ppm): 10.04 (s, 8H), 8.21 (s, 8H), 7.95 (s, 16H), 7.06 (s, 56H), 6.48 (s, 16H), 4.61 (s, 16H), 4.39 (s, 16H), 3.89 (s, 16H), 3.71 (s, 16H), 2.89 (s, 32H), 2.73 (s, 32H), 2.28 (s, 24H), 2.03 (s, 16H), 1.66 (s, 48H), 1.65 (s, 16H). m/z (ESI, positive mode): 942.49 [M+4Na⁺]/4 (calc=942.50) 1268.31 [M+3Na⁺]/3 (calc=1268.48), 1920.45 [M+2Na⁺]/2 (calc=1920.45).

### Ligand IPr.HBr 6

Calixarene 3 (3 g, 1.24 mmol), diisopropylimidazole (4.24 g, 18.57 mmol) and sodium bromide (12.65 g, 124 mmol) were placed in a reactor under argon. 30 ml of anhydrous DMF was added. 3 vacuum/argon were performed, and the mixture was heated at 80° C. for 4 days. Dichloromethane (20 ml) was added and the mixture was filtered through celite. The solution was evaporated to dryness and the white solid obtained was solubilized in a minimum of dichloromethane. The product was precipitated with diethyl ether (80 ml), filtered, rinsed with ether and the cake was dried in vacuo. 4.62 g of white product was obtained (yield: 81%). ¹H NMR (DMSO-d6, ppm): 9.87 (s, 8H), 8.21 (s, 8H), 8.12 (s, 8H), 7.61 (t, 8H), 7.42 (d, 16H), 7.02 (s, 40H), 6.52 (s, 16H), 4.56 (s, 16H), 4.42 (s, 16H), 3.79 to 3.87 (m, 32H), 2.19 (quintet, 16H), 2.07 (s, 16H), 1.71 (s, 16H), 1.08 (s, 96H). m/z (ESI, positive mode): 1071.29 [M−3Br]³⁺/3 (calc=1071.03), 1455.03 [M−3Br]³⁺/3 (calc=1454.68).

### Example 4: Preparation of the Salen Ligands

### Intermediate 14

Calixarene 3 (10 g, 4.13 mmol) and sodium azide NaN₃ (6.8 g, 103 mmol) were introduced in a reactor. The mixture was dried under vacuum for 30 min and anhydrous DMF (50 ml) was added under argon, and three vacuum/argon cycles were applied to inert the medium. The solution was stirred at 65° C. for 30 h and allowed to cool to room temperature. A saturated NaCl solution was added to precipitate the product which was then filtered. The white solid obtained was washed several times with water, methanol and finally with pentane, dried under vacuum to give 8.8 g of a white powder (yield: 86%). ¹H NMR (CDCl₃, ppm): 7.17 (s, 40H), 6.55 (s, 16H), 4.67 (s, 16H), 3.95 (s, 16H), 3.62 to 3.65 (m, 16H), 3.20 to 3.17 (m, 16H), 1.69 (bs, 32H). ¹³C NMR (CDCl₃, ppm): 154.7; 148.9; 137.0; 134.8; 128.3; 127.7; 127.5; 114.9; 72.9; 69.7; 51, 2; 30.2; 27.4; 25.8. m/z (ESI, positive mode): 2496.1626 [M+Na⁺] (calc=2496.1710).

### Intermediate 15

Calixarene 14 (1.21 g, 0.49 mmol) and the alkyne A (0.894 g, 4.42 mmol) were placed in a reactor under an argon atmosphere and dichloromethane (15 ml) was added. An aqueous solution (15 ml) of copper sulphate pentahydrate CuSO₄.5H₂O (0.1 1 g, 0.442 mmol) and sodium ascorbate (0.167 g, 0.88 mmol) was added to the reactor. The biphasic solution was stirred at room temperature under argon for 24 h. Dichloromethane (20 ml) was added and the biphasic solution was washed with a saturated solution of sodium bicarbonate NaHCO₃ (35 ml). The aqueous phase was extracted 3 times with dichloromethane (30 ml). The organic phase was dried over magnesium sulphate and evaporated. The solid obtained was solubilized in a minimum amount of dichloromethane, precipitated with ether, filtered and dried under vacuum. 5 g of a yellow solid was obtained (yield=75%). ¹H NMR (DMSO-d₆, ppm): 11.74 (s, 8H), 9.85 (s, 8H), 8.37 (s, 8H), 7.86 (s, 8H), 7.89 (s, 8H), 7.02 (s, 40H), 6.45 (s, 16H), 4.58 (bs, 16H), 4.27 (bs, 16H), 3.85 (bs, 16H), 3.55 (bs, 16H), 1.91 (bs, 16H), 1.55 (bs, 16H), 1.30 (s, 72H). ¹³C NMR (DMSO-d₆, ppm): 197.2; 158.4; 152.9; 147.5; 144.4; 136.7; 135.7; 133.5; 129.5; 127.4; 127.0; 126.4; 126.3; 121.3; 119.6; 119.5; 113.5; 71.3; 68.0; 48.3; 33.4; 27.8; 27.7; 25.6; 25.5. m/z (MALDI, DCTB matrix): 4223.01 [M+Cs⁺] (calc=4222.88). Elemental analysis: C=72.7% (calc=72.3%), H=6.5% (calc=6.6%), N=8.2% (calc=7.7%), O=12.5% (calc=11.5%).

### Ligand 16

In a reactor under argon was charged the ammonium monochloride of cyclohexanediamine C (0.366 g, 2.43 mmol), 3,5-di-tert-butyl-2-hydroxybenzaldehyde B (0.569 g, 2.43 mmol) and 3 A molecular sieves (1 g), followed by anhydrous methanol (20 ml). The reaction was stirred at room temperature for 4 h and then a solution of calixarene 15 (1.1 g, 0.27 mmol) in anhydrous dichloromethane (30 ml) was added under argon. Triethylamine (0.965 ml, 7.02 mmol) was added under argon and the mixture was stirred for 16 h at room temperature. The solution was filtered through celite and evaporated. The solid obtained was washed with methanol and with ethanol. The yellow solid was dissolved in a minimum of diethyl ether and precipitated with ethanol. The solid was filtered and dried under vacuum to give 1.4 g of a yellow solid (yield: 79%). ¹H NMR (CDCl₃, ppm): 14.12 (s, 8H), 13.58 (s, 8H), 8.28 (s, 8H), 8.19 (s, 8H), 7.68 (s, 8H), 7.61 (s, 8H), 7.43 (s, 8H), 7.03 to 6.95 (m, 40H), 6.46 (s, 16H), 4.55 (bs, 16H), 4.13 (bs, 16H), 3.86 (bs, 16H), 3.54 (bs, 16H), 3.24 (bs, 16H), 1.79-1.88 (m, 48H), 1.79 (m, 48H, 1.38 (s, 72H), 1.36 (s, 72H), 1.20 (s, 72H)¹³C NMR (CDCl₃, ppm): 166.0; 165.3; 160.7; 158.0; 154.9; 149.0; 147.6; 140.1; 137, 9; 136.9; 136.5; 134.9; 128.4; 127.8; 127.6; 127.1; 127.0; 126.1; 120.7; 119.0; 118 8; 117.9, 115.2; 72.9; 72.6; 71.9; 69.9; 50.1; 35.1; 35.0; 34.13; 33.2; 33.1; 31.5; 30.3; 29.5; 29.4; 27.3; 24.3 m/z (MALDI, DCTB matrix.): 6724 [m+Cs⁺] (calc=6721) Elemental analysis: C=75.7% (calc=74.5%), H=7.9% (calc=7.9%), N=8.3% (calc=8.5%), O=7.9% (calc=7.7%). [a]_{D}²⁰=+105.34 (c=0.002 M in CHCl₃).

### Example 5: Preparation of the Catalysts

### Preparation of Rhodium Catalyst 7

Calixarene 3 (3.28 g, 0.9 mmol) and chloro(1,5-cyclooctadiene)rhodium(I) dimer (1.87 g, 3.8 mmol) were introduced in a reactor and dried in vacuo. Under argon was added 30 ml of anhydrous dichloromethane and the reaction medium was placed for 2 hours at room temperature. The mixture was filtered on filter paper and dichloromethane was evaporated. The residue was dissolved in a minimum amount of dichloromethane and precipitated with diethyl ether. 4.05 g of a yellow-orange powder was obtained (yield: 80%). ¹H NMR (CD₂Cl₂, ppm): 7.64 (m, 4H), 7.32 (m, 48H), 7.01 (s, 40), 6.56 (s, 16H), 5, 41 (s, 16H), 4.48 (s, 16H), 3.97 (s, 16H), 3.79 (s, 16H), 3.05 (s, 16H), 1.66-2.5 (m, 14H). ³¹P NMR (CD₂Cl₂, ppm): 26.26 (d, J_{P-Rh}=148.9 Hz). Elemental analysis: C=62.38% (calc=62.36%), H=5.47% (calc=5.71%).

### Preparation of Palladium Catalyst 8

Calixarene 5 (3 g, 0.79 mmol), potassium carbonate (3 g, 21.7 mmol, dried under vacuum with heat for 30 min) and palladium chloride (1.5 g, 8.5 mmol) were introduced in a reactor. The mixture was dried under vacuum for 30 min and then 25 ml of 3-chloropyridine was added under argon. 3 vacuum/argon cycles were performed, and the mixture was heated with stirring at 100° C. for 48 h. The solution was diluted with 60 ml of dichloromethane and was centrifuged, the solid byproducts were separated by filtration and the dichloromethane and a portion of the chloropyridine were evaporated. Then, the complex was precipitated with diethyl ether. A white-brown solid was obtained, which was filtered and washed with diethyl ether. After drying in vacuo 3.61 g of product was obtained (yield: 78%). ¹H NMR (DMSO, ppm): 8.63 (s, 8H), 8.56 (d, 8H), 7.97 (d, 8H), 7.49 (s, 8H), 7.33 (s, 16H), 7.25 (s, 8H), 7.01 (s, 8H), 6.97 (s, 40H). Elemental analysis: C=55.2% (calc=56.5%), H=4.6% (calc=4.6%), N=5.6% (calc=5.7%).

### Preparation of Palladium Catalyst 8′

Calixarene 5 (0.5 g, 0.13 mmol), potassium carbonate (0.72 g, 5.2 mmol, dried under heat and vacuum for 30 min), potassium iodide (0.863 g, 5.2 mmol, dried under heat and vacuum for 30 min) and palladium iodide (0.443 g, 1.23 mmol). Drying was performed for 30 min under vacuum and 5 ml of pyridine was added under argon. 3 vacuum/argon cycles were performed, and the mixture was heated with stirring at 100° C. for 48 h. The solution was diluted with 20 ml of dichloromethane and centrifuged. The solid byproducts were separated by filtration and the dichloromethane and pyridine was evaporated. The product was dissolved in a minimum amount of dichloromethane, and the complex was precipitated with diethyl ether, filtered and rinsed with diethyl ether. After drying under vacuum, 0.655 g of a yellow solid was obtained (yield: 71%). ¹H NMR (DMSO-d₆, ppm): 8.46 (d, J=4.3 Hz, 16H), 7.72 (m, 8H), 7.47 (s, 8H), 7.27 (s, 8H), 7.20-7.23 (m, 24H), 6.97 to 7.03 (m, 56H), (s, 40H), 6.54 (bs, 16H), 4.57 (bs, 32H), 3.98 (bs, 16H), 3.86 (bs, 16H), 2.28 (s, 24H), 2.19 (s, 48H), 1.79 (s, 16H). Elemental analysis: C=46.89% (calc=47.13%), H=4.03% (calc=4.18%) N=4.63% (calc=4.71%).

### Preparation of Palladium Catalyst 8″

Calixarene 5 (0.5 g, 0.13 mmol), potassium carbonate (0.72 g, 5.2 mmol, dried under heat and for 30 min), potassium bromide (0.619 g, 5.2 mmol, dried under heat and vacuum for 30 min) and palladium bromide (0.33 g, 1.23 mmol) were introduced in a reactor. Drying was performed for 30 min under vacuum and 5 ml of pyridine was added under argon. 3 vacuum/argon cycles were performed, and the mixture was heated with stirring at 100° C. for 48 h. The solution was diluted with 20 ml of dichloromethane and centrifuged. The solid byproducts were separated by filtration the dichloromethane and pyridine were evaporated. The product was dissolved in a minimum amount of dichloromethane, and the complex was precipitated with diethyl ether, filtered and rinsed with diethyl ether. After drying in vacuo 0.431 g of a yellow solid was obtained (yield: 52%). ¹H NMR (DMSO-d₆, ppm): 8.51 (s, 16H), 7.77 (s, 8H), 6.98 to 7.24 (m, 88H), 6.53 (s, 16H), 4.63 (bs, 32H), 3.92 (bs, 32H), 2.28 (s, 24H), 2.13 (s, 48H), 1.91 (s, 16H).

### Preparation of Palladium Catalyst 9

Calixarene 6 (0.3 g, 6.5.10⁻² mmol), potassium carbonate (0.36 g, 2.6 mmol, dried under heat and vacuum for 30 min) and palladium bromide (0.15 g, 0.55 mmol) were introduced in a reactor. Drying was performed for 30 min under vacuum and 5 ml of pyridine was added under argon. 3 vacuum/argon cycles were performed, and the mixture was heated with stirring at 100° C. for 48 h. The solution was diluted with 20 ml of dichloromethane and centrifuged. The solid byproducts were separated by filtration the dichloromethane and pyridine were evaporated. The product was dissolved in a minimum amount of dichloromethane, and the complex was precipitated with diethyl ether, filtered and rinsed with diethyl ether. After drying in vacuo 0.35 g of a yellow solid was obtained (yield: 79%). ¹H NMR (DMSO-d₆, ppm): 8.51 (s, 32H), 7.76 (s, 8H), 7.47 (s, 24H), 7.28-7.32 (m, 40H), 7.04 (s, 40H), 6.54 (s, 16H), 4.57 to 4.66 (m, 32H), 3.93 (s, 32H), 2.83 (s, 16H), 2.34 (s, 16H), 1.84 (s, 16H), 1.24 (s, 48H), 0.91 (s, 48H). Elemental analysis: C=54.46% (calc=54.27%), H=4.78% (calc=5.00%) N=5.19% (calc=5.27%).

### Preparation of the Palladium Catalyst 13

Potassium carbonate (586 mg, 4.24 mmol) was introduced in a reactor and dried with heating under vacuum. Palladium chloride (261 mg, 1.47 mmol), calixarene 12 (500 mg, 0.14 mmol) and 3-chloropyridine (3 ml) were added at room temperature. Three vacuum-argon cycles were carried out and the mixture was heated for 36 h at 100° C. The medium was diluted with dichloromethane (10 ml), centrifuged and filtered. The solvents were evaporated, and the product was dissolved in a minimum of dichloromethane. The product was precipitated with diethyl ether/pentane and filtered. After drying, 469 mg of product was obtained (60% yield). ¹H NMR (DMSO-d₆, ppm): 8.65 (s, 8H), 8.57 (s, 8H), 8.01 (s, 8H), 7.54 (s, 8H), 7.40 (s, 8H), 7.31 (s, 8H), 6.97 (s, 16H), 6.91 (s, 16H), 4.68 (s, 16H), 4.00 (s, 16H), 3.80 (s, 16H), 2.28 (s, 40H), 2.08 (s, 48H), 1.81 (s, 16H), 0.96 (s, 72H). Elemental analysis: C=55.54% (calc=55.43%) H=5.70% (calc=5.52%) N=5.65% (calc=6.06%).

### Preparation of the Cobalt Catalyst 17

In a reactor under argon, were introduced calixarene 16 (0.5 g, 0.075 mmol) and dichloromethane (10 ml) and the mixture was stirred until completely dissolved. A solution of Co(OAc)₂.3H₂O (0.187 g, 0.75 mmol) in anhydrous methanol (6 ml) was added to the solution of calixarene 16 under argon. The reaction was allowed to stir for 4 h at room temperature. The mixture was cooled to 0° C. followed by addition of para-toluenesulfonic acid (0.143 g, 0.75 mmol) and additional 5 ml of dichloromethane was added. The reaction was placed under 1 atm of pure oxygen and stirred at room temperature for 16 h. The solution was evaporated and the solid was washed several times with methanol and dried under vacuum. A green solid was obtained 0.534 g (yield=84%). ¹H NMR (DMSO-d₆, ppm): 8.37 (s, 8H); 8.03 (s, 8H); 7.91 (s, 8H); 7.81-7.83 (m, 16H); 7.46-7.48 (m, 32H); 7.03-7.08 (m, 56H); 6.54 (bs, 16H); 4.64 (bs, 16H); 4.51 (bs, 16H); 3.92 (bs, 8H); 3.61 (s, 24H); 3.05 (s, 16H); 2.25 (s, 24H); 1.89-1.94 (m, 48H), 1.73-1.74 (m, 144H), 1.46-1.56 (m, 48H), 1.30 (s, 72H). ¹³C NMR (DMSO-D₆, ppm): 165.2; 164.7; 164.6; 162.2; 154.4; 147.0; 146.4; 143.4; 142.1; 137.9; 137.2; 136.5; 130.8; 129.7; 129.4; 129.0; 128.4; 127.8; 125.9; 119.7; 119.0; 117.6; 69.8; 69.4; 49.7; 49.0; 36.2; 36.1; 34.0; 31, 9; 30.8; 30.6; 29.8; 27.2; 24.7; 21:1. Elemental analysis calculated for calixarene 17+5CH₂Cl₂:C=64.3% (calc=64.8%), H=6.5% (calc=6.5%), N=6.6% (calc=6.3%), S=2.3% (calc=2.9%). [a]_{D}²°=+1020.4° (c=8.10⁻⁵ M in DMF).

### Example 6: Use of the Palladium Catalysts for the Suzuki Coupling Reaction

### Example 6.1: Coupling Between Bromotoluene and Phenylboronic Acid

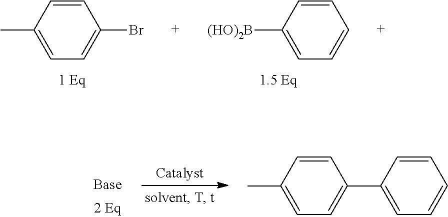

Standard Protocol:

Catalyst 8 (7.4 mg, 1.10⁻⁵ mol, 1 mol %), phenylboronic acid (182.9 mg, 1.5.10⁻³ mol, 1.5 eq) and potassium phosphate tribasic (424.5 mg, 2.10⁻³ mol, 2 eq) wre introduced in a reactor. The mixture was dried under vacuum for 10 min and bromotoluene (171 mg, 1.10⁻³ mol, 1 eq) was added. The medium is placed under argon and anhydrous ethanol (2 ml) was added. 3 vacuum/argon cycles were carried out and the mixture heated with stirring at 40° C. for 2 h. The reaction was monitored by gas chromatography. When coupling dihalogenated substrates, the number of equivalents of boronic acid and base was modified/In the case of 1,2-dibromobenzene: 3 eq of base and boronic acid; in the case of 1,9-dibromoanthracene and 1,2-dichlobenzene: 3 eq of base, 2.5 eq of boronic acid.

The results of the Suzuki coupling with the catalysts 8 and 9, with respect to the temperature and loading of the catalyst are presented in Tables 1 and 1′.

The results of the Suzuki coupling with the catalysts 8 and 9, with respect to the solvent, are presented in Table 2.

The results of the Suzuki coupling with the catalysts 8 and 9, with respect to the base are shown in Table 3.

The results of the Suzuki coupling, with respect to the catalyst are presented in Tables 4 and 4′.

The results of the Suzuki coupling reactions, with respect to the concentration of reagents, are presented in Table 5.

TABLE 1
Temperature and catalyst loading. K₃PO₄, 0.5M in bromotoluene,
1 5 eq in boronic acid, ethanol, 2 h.

| T (° C.) | Pd (mol %) | Catalyst | Conversion (%) | Yield (%) |
|---|---|---|---|---|
| 27 | 0.1 | 8 | 98 | 90 |
| | | 9 | 91 (95/6 h) | 86 |
| | 0.05 | 8 | 92 (99/22 h) | 81 |
| | 0.01 | 8 | 70 (93/22) | |
| 40 | 0.05 | 8 | 97 | 85 |
| | | 9 | 93 (97/23 h) | 84 |
| | 0.01 | 8 | 91 (96/23 h) | 87 |
| | | 9 | 89 (95/23 h) | 82 |
| | 0.005 | 8 | 81 (92/23 h) | |
| 80 | 0.005 | 8 | 92 | 84 |
| | | 9 | 97 | 91 |
| | 0.001 | 8 | 93 | 71 |
| | | 9 | 91 | 72 |

TABLE 1′
temperature and catalyst loading. K₃PO₄, 0.25M
in bromotoluene, isopropanol, catalyst 8, 23 h.

| T (° C.) | Pd (mol %) | Conversion (%) |
|---|---|---|
| 27 | 0.5 | 93 |
| 40 | 2 | 100 |
| | 0.5 | 100 |
| | 0.1 | 100 |
| | 0.05 | 100 |
| | 0.01 | 95 |
| 80 | 0.01 | 96 |
| | 0.005 | 98 |
| | 0.0025 | 74 |

TABLE 2
Nature of the solvent. K₃PO₄ 0.25M in bromotoluene,
Pd = 0.5 mol %, 27° C., 2 h.

| | Conversion | Conversion |
|---|---|---|
| Solvant | catalyst 8 (%) | catalyst 9 (%) |
| MeOH | 71 (76/6 h) | 73 (81/6 h) |
| EtOH | 98 | 99 |
| EtOH anh | 99 | |
| EtOH—H₂O 7/1 | 92 (99/6 h) | |
| iPrOH | 74 (99/22 h) | 53 (91/22 h) |
| PrOH | 97 (99/4 h) | 95 (99/6 h) |
| t-BuOH | 6 (84/22 h) | 2 (66/22 h) |
| BuOH | 94 (100/6 h) | 95 (99/6 h) |
| Acetonitrile | 0 | 0 |
| DMF | 0 | 0 |
| DMF—H₂O 7/1 | 67 (99/23 h) | |
| THF | 0 | 0 |
| THF—H₂O 7/1 | 10 (17/6 h) | |
| Toluene | 22 (32/23 h) | 12 (26/23 h) |
| Toluene-H₂O 7/1 | 72 (90/22 h) | |

TABLE 3
Nature of the base. Bromotoluene 0.25M in ethanol,
Pd = 0.5 mol %, 27° C.

Conversion (%)

| Catalyst | Base | t = 2 h | t = 23 h |
|---|---|---|---|
| 8 | K₃PO₄ | 98 | |
| | K₂CO₃ | 67 | 92 |
| | AcONa | 15 | 29 |
| | KOH | 53 | 64 |
| 9 | K₃PO₄ | 99 | |
| | K₂CO₃ | 59 | 95 |
| | Bu₄N⁺OH⁻ | 3 | 64 |
| | AcONa | 14 | 26 |
| | KOH | 53 | 60 |

TABLE 4
Nature of the catalyst. Conditions 1: K₃PO₄, 0.5M in bromotoluene,
ethanol, Pd = 0.005 mol %, 80° C., 2 h. Conditions 2: K₃PO₄
0.25M in bromotoluene, ethanol, Pd = 0.5 mol %, 27° C., 2 h.

| | Conditions 1, | Conditions 2, |
|---|---|---|
| Catalyst | conversion (%) | conversion (%) |
| 8 | 92 | 98 |
| 8′ | 40 | |
| 9 | 97 | 99 |
| 13 | 85 | 98 |

TABLE 4′
Nature of the catalyst. K₃PO₄, 0.25M in bromotoluene,
isopropanol, Pd = 0.5 mol %, temperature, 23 h.

| Catalyst | T (° C.) | Pd (mol %) | Conversion (%) |
|---|---|---|---|
| 8 | 27 | 0.5 | 99 |
| 9 | 27 | 0.5 | 91 |
| 8 | 40 | 0.1 | 100 |
| 13 | 40 | 0.1 | 88 |

TABLE 5
Concentration of the mixture. K₃PO₄, ethanol, Pd =
0.5 mol %, catalyst 8, 27° C., 2 h.

| C_{Substrate} (M) | Conversion (%) |
|---|---|
| 0.125 | 93 (98/23 h) |
| 0.25 | 98 |
| 0.5 | 99 |

### Example 6.2: Suzuki Coupling Between Various Brominated Substrates and Various Boronic Acids

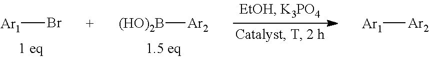

The results are presented in Table 6 below.

TABLE 6
Conversion, selectivity and yield of the Suzuki coupling reaction between
various brominated substrates and boronic acids. K₃PO₄, ethanol, 2 h.

| | | | | | | | | Iso- |
|---|---|---|---|---|---|---|---|---|
| | | | Pd | | | | | lated |
| Halogen | Boronic acid | T | (mol | | C_{Substrate} | Conversion | Selectivite | yield |
| Ar₁—Br | (HO)₂B—Ar₂ | (° C.) | %) | Cata. | (M) | (%) | (%) | (%) |
| 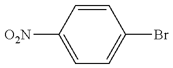 | 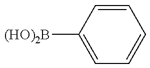 | 27 | 0.05 0.01 | 8 8 9 | 0.25 0.25 0.25 | 100 74 (100/5 h) 37 (100/23 h) | | |
| 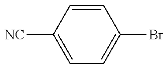 | 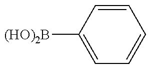 | 40 27 40 | 0.01 0.05 0.01 | 8 8 8 | 0.25 0.5 0.5 | 100 90 (100/4 h) 81 (98/23 h) | 100 100 (100) | 100 |
| 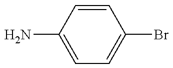 | 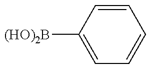 | 80 | 0.01 | 8 9 | 0.5 0.5 | 100 100 | 100 99 | |
| 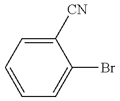 | 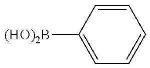 | 80 | 0.1 | 8 | 0.5 | 100 | | |
| 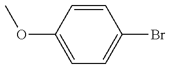 | 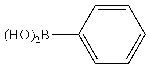 | 80 | 0.05 | 8 | 0.5 | 97 | 96 | |
| 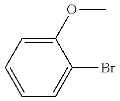 | 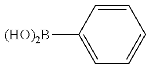 | 80 | 1 | 8 9 | 0.5 0.5 | 94 98 | 97 98 | |
| 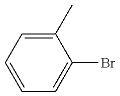 | 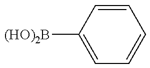 | 80 | 1 | 8 9 | 0.5 0.5 | 99 100 | 100 100 | |
| 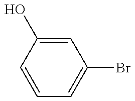 | 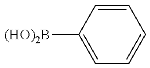 | 80 | 0.5 | 9 | 0.5 | 90 | 100 | |
| 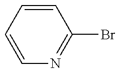 | 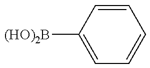 | 80 | 2 | 8 9 | 0.5 0.5 | 89 95 | 85 91 | |
| 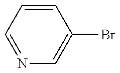 | 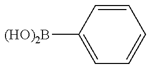 | 80 | 2 | 8 | 0.5 | 100 | 99 | |
| 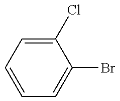 | 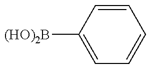 | 80 | 0.5 | 9 | 0.5 | 100 | 77 | |
| 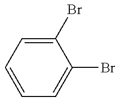 | 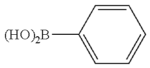 | 80 | 2 | 8 9 | 0.5 0.5 | 98 100 | 88 100 | |
| 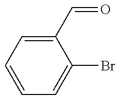 | 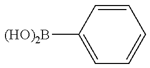 | 80 | 0.5 | 9 | 0.5 | 100 | 100 | |
| 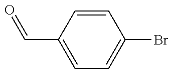 | 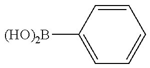 | 80 | 0.05 | 8 | 0.5 | 100 | 100 | |
| 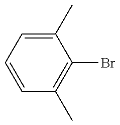 | 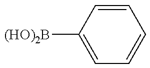 | 80 | 2 | 9 | 0.5 | 100 | 98 | |
| 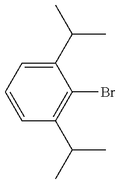 | 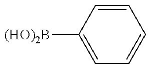 | 80 | 2 | 9 | 0.5 | 60 | 51 | |
| 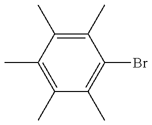 | 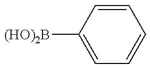 | 80 | 2 | 8 9 | 0.5 0.5 | 51 74 | 89 89 | |
| 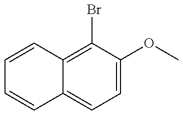 | 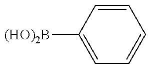 | 80 | 1 | 9 | 0.5 | 100 | 95 | 95 |
| 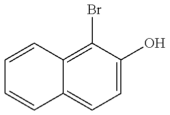 [SMILES: Oc1ccc2ccccc2c1Br] | 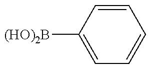 | 80 | 2 | 9 | 0.5 | 73 | | |
| 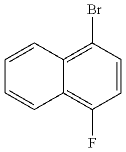 [SMILES: Fc1ccc(Br)c2ccccc12] | 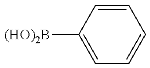 | 80 | 0.01 | 8 | 0.5 | 98 | 100 | |
| 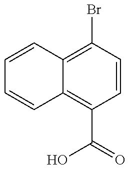 [SMILES: O=C(O)c1ccc(Br)c2ccccc12] | 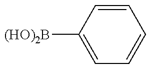 | 80 | 0.05 | 8 | 0.5 | 100 | | |
| 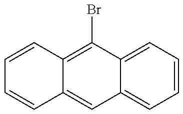 [SMILES: Brc1c2ccccc2cc2ccccc12] | 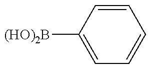 | 80 | 0.01 | 9 | 0.25 | 97 | 94 | |
| 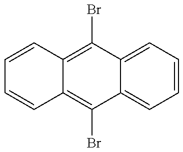 [SMILES: Brc1c2ccccc2c(Br)c2ccccc12] | 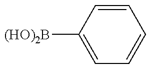 | 80 | 0.2 | 8 9 | 0.25 99 | 17 95 | | |
| 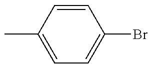 | 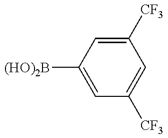 [SMILES: OB(O)c1cc(C(F)(F)F)cc(C(F)(F)F)c1] | 80 | 0.5 | 8 | 0.5 | 98 | 99 | |
| 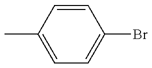 | 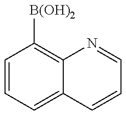 [SMILES: OB(O)c1cccc2cccnc12] | 80 | 2 | 8 | 0.5 | 97 | 98 | |
| 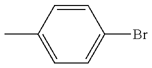 | 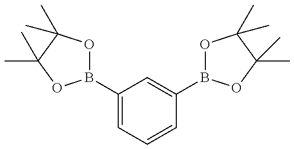 | 80 | 0.5 | 8 | 0.5 | 100 | 85 | |
| 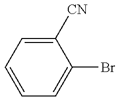 | 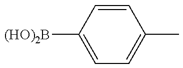 | 80 | 0.1 | 8 | 0.5 | 100 | 95 | 95 |
| 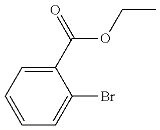 | 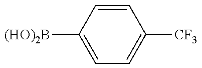 [SMILES: OB(O)c1ccc(C(F)(F)F)cc1] | 80 | 1 | 8 | 0.5 | 19 (90/96 h) | 91 (98) | |

### Example 6.3: Suzuki Coupling Between Various Chlorinated Substrates and Phenylboronic Acid

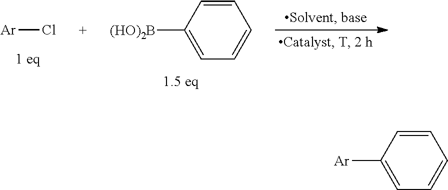

The results are presented in Table 7 below.

TABLE 7
Conversion and selectivity of the Suzuki coupling reaction between various
chlorinated substrates and phenylboronic acid. K₃PO₄, solvent, temperature, 2 h.

| | | | | | | C_{Substrate} | | |
|---|---|---|---|---|---|---|---|---|
| | T | Pd | | | | (1 eq) | Conversion | Selectivity |
| Halogen | (° C.) | (mol %) | Cat. | Base | Solvent | (M) | (%) | (%) |
| 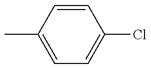 | 80 100 | 2 2 | 8 9 8 | K₃PO₄ K₃PO₄ K₃PO₄ Cs₂CO₃ Cs₂CO₃ | EtOH EtOH BuOH DMF/H₂O 70/30 NMP/H₂O 70/30 | 0.5 0.5 0.5 0.25 0.25 | 57 43 44 70 (93/23 h) 49 (76/24 h) | 74 83 |
| 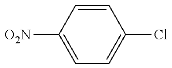 | 100 | 0.5 | 8 | K₃PO₄ | BuOH | 0.5 | 99 | |
| 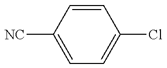 | 100 | 1 | 8 | K₃PO₄ | BuOH | 0.5 | 54 | |
| 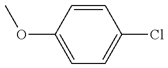 | 100 | 1 | 8 | K₃PO₄ | BuOH | 0.25 | 23 | |
| 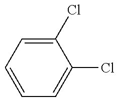 | 80 | 2 1 | 9 9 | K₃PO₄ K₃PO₄ | EtOH EtOH | 0.5 0.5 | 63 50 | 68 M, 32 D 77 M, 24 D |
| 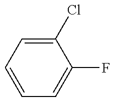 | 80 | 2 | 8 | K₃PO₄ | EtOH | 0.5 | 47 | 95 |

### Example 6.4: Studies on the Residual Palladium Content in the Products Obtained from the Suzuki Coupling

All glassware used was subsequently washed with nitric acid and rinsed with ultrapure water. Suzuki couplings were performed according to the protocol presented in Example 6.1, starting from 1 mmol. After 2 h of reaction, the reaction medium was cooled and left for 30 min at room temperature without stirring. The medium was then filtered on grade 5 filter paper and the cake was rinsed with ethanol. The filtrate was condensed under vacuum and diethyl ether or ethyl acetate (10 ml) was added followed by water. The aqueous phase was then extracted with 3×10 ml of diethyl ether or ethyl acetate. After combining, drying and condensing under vacuum of the organic phases, the product was evaporated under vacuum at 200° C. for one hour. The residue was mineralized in a flask fitted with a reflux condenser by adding 4 ml of concentrated nitric acid which was brought at reflux with stirring for 1 hour until a clear and homogeneous solution was obtained. The solution was then analyzed by ICP-MS. A metal content, expressed in milligrams of palladium per kilogram of product derived from the Suzuki coupling, was obtained.

The results obtained as a function of the catalyst loading are presented in Tables 8 and 8′:

TABLE 8
Residual palladium content in the products obtained from the Suzuki
coupling. K₃PO₄ 0.5 M substrate, ethanol, 80° C., 2 h.

| | | | | | | Palladium |
|---|---|---|---|---|---|---|
| | | | | | | non- |
| Substrate | Boronic acid | Pd | | Conversion | [Pd]_{Product} | leached |
| Ar₁—Br | (HO)₂B—Ar₂ | (mol %) | Catalyst | (%) | (ppm) | (%) |
| 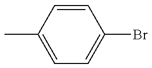 | 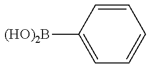 | 0.5 | 8 9 13 | 100 100 100 | 10.6 50.8 161.6 | 99.7 98.6 95.4 |
| 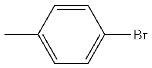 | 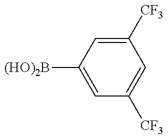 [SMILES: OB(O)c1cc(C(F)(F)F)cc(C(F)(F)F)c1] | 0.5 | 8 | 100 | 66.3 | 98.1 |
| 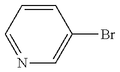 | 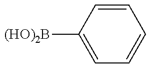 | 2 | 8 | 100 | 78.7 | 99.4 |
| 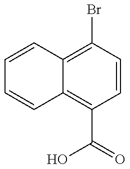 [SMILES: O=C(O)c1ccc(Br)c2ccccc12] | 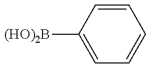 | 0.05 | 8 | 100 | 13.4 | 97.2 |
| 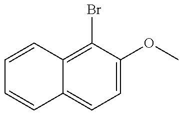 | 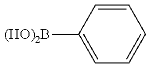 | 1 | 9 | 100 | 31.5 | 99.6 |

TABLE 8′
Residual palladium content in the products
obtained from the Suzuki coupling.
K₃PO₄, 0.25M bromotoluene, 1.5 eq phenylboronic
acid, imidazoleanol, catalyst 8, 40° C., 23 h.

| Pd (mol %) | ppm (mg · kg⁻¹) |
|---|---|
| 1 | 10.8 |
| 0.5 | 7.2 |
| 0.1 | 7.9 |
| 0.05 | 4.4 |

### Example 7: Other Uses of the Metal Complexes

### Example 7.1: Use of the Rhodium Catalyst in a Hydrogenation Reaction

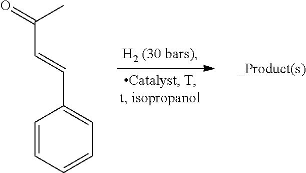

Standard Protocol:

Calixarene 7 (3.36 mg, 5.5.10⁻⁷ mol, 0.3 mol %), benzylideneacetone (214.3 mg, 1.467.10⁻³ mol) and isopropanol (10 ml) were introduced in an autoclave. The reactor was placed under dihydrogen atmosphere by performing two compression (10 bar)/decompression cycles and injecting 30 bars. The medium was stirred at room temperature and its composition was analyzed with gas chromatography coupled to electrospray mass spectrometry. The results are shown in the Table 9 below.

TABLE 9
Use of the rhodium catalyst 7 for the hydrogenation reaction.
Solvent: isopropanol

| Catalyst loading | T | t | Conversion | 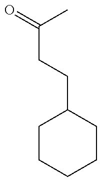 | 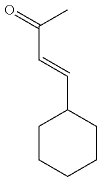 | 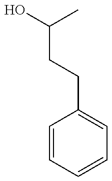 | 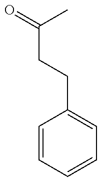 |
|---|---|---|---|---|---|---|---|
| 1% | 100° C. | 2 h | 100% | 88.6% | 11.4% | | |
| 0.05% | 100° C. | 2 h | 60% | 3.7% | | 3% | 52.6% |
| 1.5% | TA | 22 h | 100% | 1.2% | | 2.3% | 96.5% |
| 0.3% | TA | 22 h 72 h | 18% 100% | 5.6% | | 2.5% | 92.1% |

### Example 7.2: Use of the Palladium Catalysts in the Heck Coupling

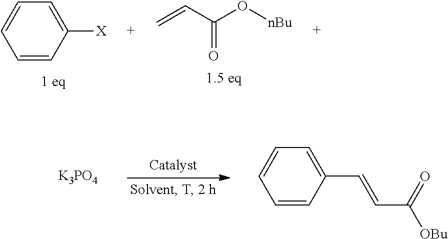

Standard Protocol:

Catalyst 8 (7.4 mg, 1.25.10⁻³, mmol) and potassium phosphate tribasic (424 mg, 2 mmol) were introduced in a reactor and dried under vacuum for 10 min. Bromobenzene (105 μl, 1 mmol), butyl acrylate (213 μl, 1.5 mmol) and anhydrous dimethylformamide (4 ml) were added under an argon atmosphere. 3 vacuum/argon cycles were performed, and the mixture was stirred at 100° C. for 18 h, giving 57% conversion.

The results are presented in the following table 10:

TABLE 10
Conversions obtained in the Heck coupling. K₃PO₄, 0.25 M of butyl acrylate, 2 h.

| | T | Pd | | | Conversion |
|---|---|---|---|---|---|
| Substrate | (° C.) | (mol %) | Catalyst | Solvent | (%) |
| 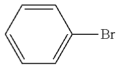 | 100 130 | 1 1 2 | 8 9 8 9 8 | DMF DMF NMP DMF DMF DMF | 57 (18 H) 6 (13/18 h) 62 (22 h) 62 (22 h) 86 (24 h) 56 (18 h) |
| 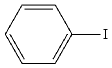 | 80 100 | 1 1 | 9 8 9 | DMF DMF DMF | 92 (100/4 h) 100 100 |

### Example 7.3: Epoxide Opening Reaction

i. Opening of Epibromohydrin

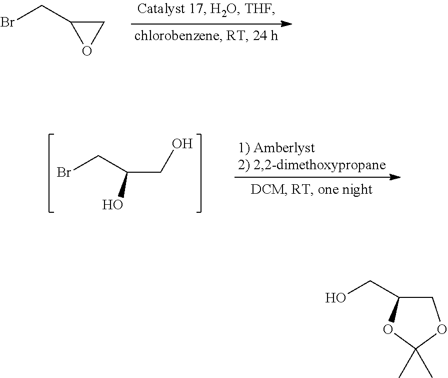

Catalyst 17 (32 mg, 0.034 mmol, 2 mol %), epibromohydrin (0.141 ml. 1.7 mmol), chlorobenzene (0.05 ml, 0.5 mmol) and 0.197 ml of THF were introduced in a reactor. Water (0.044 ml, 2.5 mmol) was added with stirring. The reaction was allowed to stir for 24 h at room temperature and 5 ml of dichloromethane, Amberlyst 15 (16 mg) and 2.2-dimethoxypropane (0.418 ml, 3.4 mmol) were added. Stirring was continued for 18 h at room temperature. The reaction was monitored by gas chromatography: the use of an achiral column provides access to the conversion and that of a chiral column to the enantiomeric excess (ee). After a first catalytic reaction, the catalyst 17 was precipitated with diethyl ether, filtered and reengaged in a new catalytic reaction with a new batch of products and solvents. The catalyst 17 was thus evaluated through three catalytic cycles.

The results are presented in Table 11 below.

TABLE 11
Conversion and enantiomeric excesses obtained in the epoxide opening
reaction

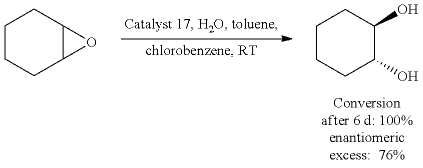 [SMILES: C1CCC2OC2C1 ; O[C@@H]1CCCC[C@H]1O]

| | Catalyst loading | Conversion | e.e. |
|---|---|---|---|
| | (mol %) | (%) | (%) |
| Cycle 1 | 2 | 100 | 94 |
| Cycle 2 | 2 | 100 | 94 |
| Cycle 3 | 2 | 43 | 94 |

Catalyst 17 (17 mg, 0.020 mmol, 2 mol %), cyclohexene oxide (0.100 ml. 0.99 mmol), chlorobenzene (0.025 ml. 0.25 mmol) and 0.210 ml of toluene were introduced in a reactor. Water (0.021 ml, 1.18 mmol) was added with stirring. The reaction was allowed to stir for 6 days at room temperature. The reaction was monitored by gas chromatography: using an achiral column provides access to the conversion and using a chiral column to enantiomeric excess. 100% conversion was obtained after 6 days, with an enantiomeric excess of 76%.

### Example 7.4: Residual Content of Cobalt in the Product Resulting from the Opening of Epibromohydrin

At the end of the reaction, the dichloromethane solution was evaporated, and the product was extracted with ether. The suspension was filtered through filter paper and the filtrate was evaporated under reduced pressure. The residue obtained was evaporated under vacuum at 200° C. for 1 h, 4 ml of concentrated nitric acid was added which was brought to reflux with stirring for 1 h until a clear and homogeneous solution was obtained. The solution was then analyzed by ICP-MS. A metal content expressed in milligrams of cobalt per kilogram of product resulting from the opening of epibromohydrin was obtained.

The result obtained is shown in Table 12:

TABLE 12
Residual cobalt content in the reaction product.

| Substrate | Co | Conversion | [Co]_{Prod.} |
|---|---|---|---|
| Ar₁—Br | (mol %) | (%) | (ppm) |
| 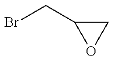 | 1 | 100 | 1.2 |

### Example 7.5: Residual Rhodium Content in the Products of the Hydrogenation Reaction

At the end of the reaction, the reaction medium was left for 30 min at room temperature, filtered, and a mineralization protocol and analysis identical to that described in the example 5.4 was used.

TABLE 13
Residual rhodium content in the hydrogenation reaction products.

| | | T | t | Conv. | [Rh]_{Prod.} |
|---|---|---|---|---|---|
| Substrate | Rh (mol %) | (° C.) | (h) | (%) | (ppm) |
| 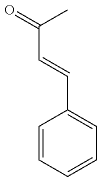 | 0.3 | RT | 49 | 98.3 | 6.2 |
| 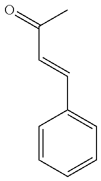 | 0.05 | 100 | 3 | 100 | 2.4 |

1-17. (canceled)

18. Compound of general formula (I): 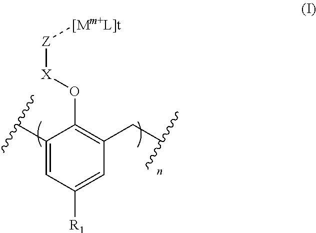
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal, and
said compound has the formula (IA) in which t is 0 and Z represents a group Q selected from the group consisting of phosphorus ligands, or the phosphonites and phosphinites, with the exception of phosphines and phosphine oxides, N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes, or salen ligands,
said compound has the formula (IB) in which t is 0 and Z represents a group Q′, a precursor of a group Q selected from the group consisting of azoliums, or 1,3-imidazolium, 1,3-imidazolinium, 1,3-benzimidazolium, 1,2,4-triazolium, 1,3-thiazolium, precursors of phosphorus ligands with the exception of phosphines and phosphine oxides, or chalcogenides, or phosphine sulfides, or salen ligands precursors, or derivatives of salicylaldehyde,
said compound has the formula (IC) wherein t is 1 and Z represents a group Q selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4 triazolylidenes and 1,3-thiazolylidenes, or salen ligands.

19. Compound according to claim 18 of general formula (I): 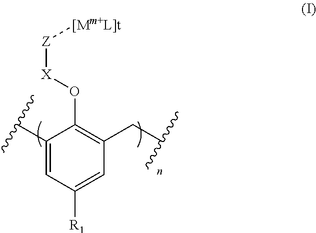
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal, and
said compound has the formula (IA) in which t is 0 and Z represents a group Q selected from the group consisting of phosphorus ligands, or the phosphonites and phosphinites, with the exception of phosphines and phosphine oxides, N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes, or,
said compound has the formula (IB) in which t is 0 and Z represents a group Q′, a precursor of a group Q selected from the group consisting of azoliums, or 1,3-imidazolium, 1,3-imidazolinium, 1,3-benzimidazolium, 1,2,4-triazolium, 1,3-thiazolium, precursors of phosphorus ligands with the exception of phosphines and phosphine oxides, or chalcogenides, or phosphine sulfides, or
said compound has the formula (IC) wherein t is 1 and Z represents a group Q selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4 triazolylidenes and 1,3-thiazolylidenes.

20. Compound according to claim 18 of the following general formula (IA): 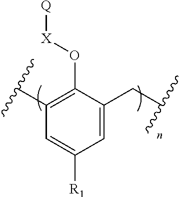
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
Q is selected from the group consisting of phosphorus ligands, or the phosphonites and phosphinites, with the exception of phosphines and phosphine oxides, N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

21. Compound according to claim 18 of the following general formula (IC): 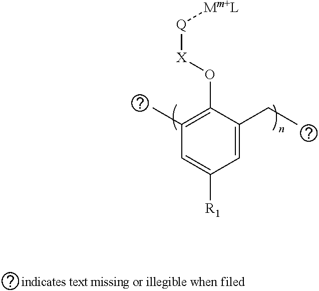
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
Q is selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes.

22. Compound of formula (I) according to claim 18, wherein
the group X is a linear alkyl chain comprising from 2 to 8 or from 3 to 8 carbon atoms, or 2, 3, 4, 5, 6, 7 or 8, or from 2 to 6 or from 3 to 6 carbon atoms, or from 2 to 4 or from 3 to 4 carbon atoms.

23. Compound of formula (I) according to claim 18, wherein
the group R₁ is selected from n-octyl, t-butyl, O-benzyl and O-alkyl or O-methyl, O-ethyl, O-propyl, or t-butyl or O-benzyl.

24. Compound of formula (I) according to claim 18, wherein n=8 or 16.

25. Compound of formula (I) according to claim 18, wherein
n represents an integer from 7 to 20,
X is a linear alkyl having 3 to 6 carbon atoms,
t is 0 and Z represents a group Q selected from the group consisting of phosphorus ligands, or phosphonites and phosphinites, with the exception of phosphines and phosphine oxides and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes, or
t is 0 and Z represents a group Q′ precursor of a group Q, selected from the group consisting of azoliums, or 1,3-imidazolium, 1,3-imidazolinium, 1,3-benzimidazolium, 1,2,4-triazolium, 1,3-thiazolium, precursors of phosphorus ligands with the exception of phosphines and phosphine oxides or chalcogenides, particularly phosphine sulfides,
t is 1 and Z represents a group Q selected from the group consisting of phosphorus ligands, or phosphines, phosphonites and phosphinites, and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes,
R₁ represents n-octyl, t-butyl, O-benzyl or O-alkyl or O-methyl, O-ethyl, O-propyl, or t-butyl or O-benzyl,
M^{m+} is a metal in oxidation state m or a metal cluster comprising a plurality of metals in the oxidation state m, where m is 0, 1, 2, 3, 4 or 5.
L consists of one or more neutral ligands or negatively charged linked to the metal.

26. Compound of formula (IC) according to claim 18: 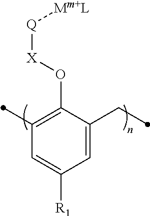
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
Q is selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes,
M^{m+} is a metal in oxidation state m or a metal cluster comprising a plurality of metals in the oxidation state m, where m is 0, 1, 2, 3, 4 or 5, or a transition metal group IB, IIB, IIIB, VA, IVB, VB, VIB, VIIB or VIIIB, or selected from the group consisting of Ni, Pd, Ru, Rh, Cu, Co or Pt, and
L consists of one or more neutral ligands or negatively charged linked to the metal.

27. Compound of formula (I) according to claim 18: 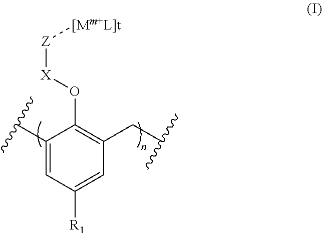
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, the aryl being or selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal, and said compound has the formula (IA) in which t is 0 and Z represents a group Q selected from the group consisting of salen ligands, or enantiopure salen ligands, or derivatives of cyclohexyldiamine and diphenylethylene and derivatives of the above salen ligands,
said compound has the formula (IB) in which t is 0 and Z represents a group Q′, a precursor of a group Q selected from the group consisting of precursors of salen ligands, or derivatives of salicylaldehyde,
said compound has the formula (IC) wherein t is 1 and Z represents a group Q selected from the group consisting of salen ligands, or enantiopure salen ligands, or derivatives of cyclohexyldiamine and diphenylethylene and derivatives of the above salen ligands.

28. Compound of formula (I) according to claim 18 selected from:

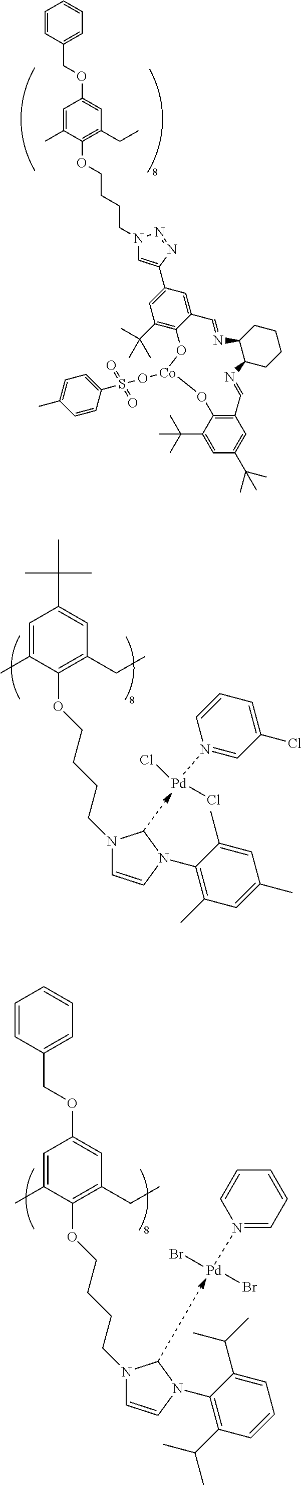

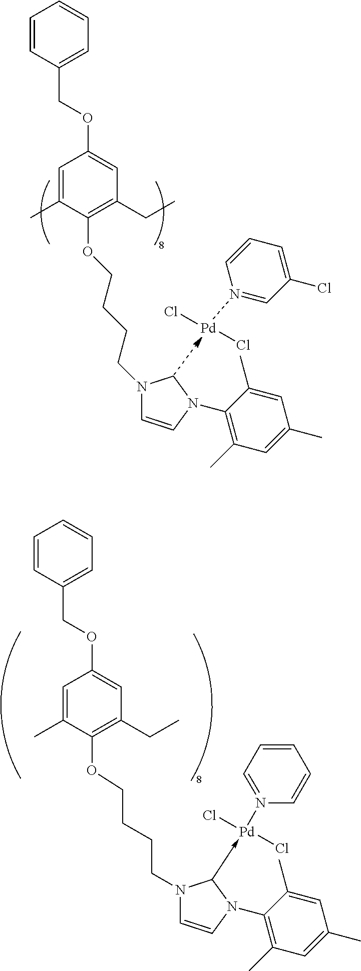

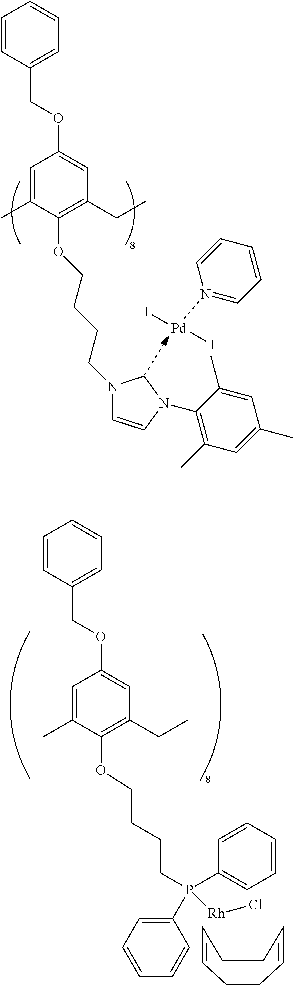

29. Method of catalyzing a reaction selected from the group consisting of reduction reactions, or reduction reactions in the presence of H₂ or the hydrogenation of carbonyl, alkene, alkyne or arene, the oxidation reactions, or oxidation reactions in the presence of O₂, the carbon-carbon bond forming reactions, or the Suzuki reaction, Heck, Stille, Kumada and Sonogashira, the carbon-heteroatom bond forming reactions, or carbon-nitrogen, carbon-oxygen, carbon-phosphorus, and carbon-sulfur bond formation, carbonylation reactions in the presence CO, or Fischer-Tropsch, the gas phase carboxylation of reactions in the presence of CO₂, and asymmetric catalysis reactions, or the epoxide opening reactions or asymmetric catalysis reactions allowing C—C or C—X bond formation, wherein the catalyst is a compound of formula (IC): 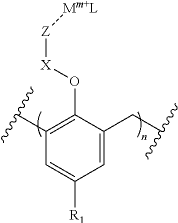
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal,
Z is selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4 triazolylidenes and 1,3-thiazolylidenes, or salen ligands.

30. Method for preparing a compound of formula (IA): 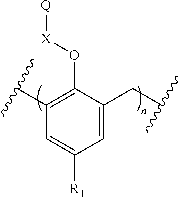
wherein
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
Q is a phosphorus ligand, or a secondary phosphonite, or a secondary phosphinite other than a phosphine and phosphine oxide,
or
a compound of formula (IB): 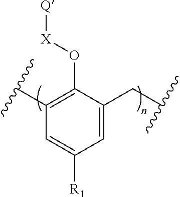
wherein
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
wherein Q′ is selected from the group consisting of azoliums, or 1,3-imidazolium, 1,3-imidazolinium, 1,3-benzimidazolium, 1,2,4-triazolium, 1,3-thiazolium
comprising a step of contacting a compound of formula (II): 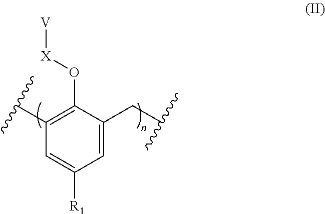
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
V represents a leaving group, or chosen from the group consisting of halogens, or Cl, Br and I and sulfonates, or OSO₂Me, OSO₂(C₇H₇) and OSO₂CF₃,
with a compound of formula QA wherein Q is selected from the group consisting of phosphorus ligands, or a secondary phosphonite, or secondary, with the exception of phosphines and phosphine oxides and A represents an alkali metal selected from the group consisting of Na, K and Li or a is H and the reaction is carried out in the presence of a base, to give a compound of formula (IA),
or with a compound of formula Q′ selected from the group consisting of azoles, or 1,3-imidazoles, 1,3-imidazoline, 1,3-benzimidazoles, 1,2,4-triazoles and 1,3-thiazoles,
or,
a compound of formula (IC): 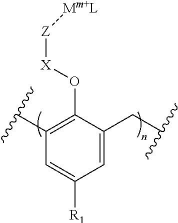
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, or the aryl being selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal,
Z represents a group Q selected from the group consisting of phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes,
comprising a step of contacting a compound of formula (IA),
said compound (IA) has the formula (I) wherein t is 0 and Z represents a group Q selected from the group consisting of phosphorus ligands, or phosphines, phosphonites, phosphinites, and N-heterocyclic carbenes, or 1,3-imidazolylidenes, 1,3-imidazolinylidenes, 1,2,4-triazolylidenes, 1,3-benzimidazolylidenes, 1,2,4-triazolylidenes and 1,3-thiazolylidenes, 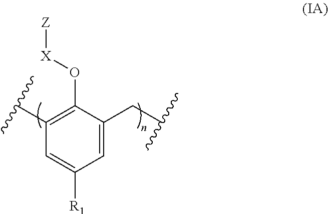
with a metal complex of formula (L′)Mⁿ⁺ where M^{m+} is a metal in oxidation state m or a metal cluster comprising a plurality of metals in the oxidation state m, where m is 0, 1, 2, 3, 4 or 5, or 0, 1, 2 or 3, and L′ is comprised of 0, one or more neutral or negatively charged ligands bound to the metal.

31. Method according to claim 30 for preparing a compound of formula (IC): 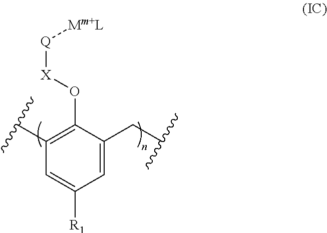
in which:
n represents an integer from 7 to 20 or greater than 20, or 21 to 220,
X is a linear or branched alkyl comprising 1 to 10 carbon atoms, a polyethylene glycol comprising from 1 to 5 units or ethylene glycol (linear or branched alkyl comprising from 0 to 10 carbon atoms)-aryl, the aryl being or selected from phenyl and naphthyl,
R₁ represents a linear or branched alkyl comprising 1 to 8 carbon atoms, O-linear or branched alkyl comprising 1 to 8 carbon atoms or O-(straight or branched alkyl of 0-3 carbon atoms)-aryl,
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal
Q is selected from the group consisting of salen ligands, or enantiopure salen ligands, or derivatives of cyclohexyldiamine and diphenylethylene and derivatives of the above salen ligands,
comprising a step of contacting a compound of formula (II): 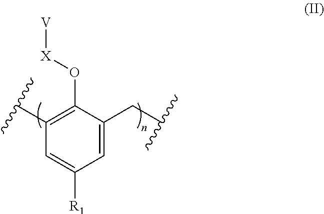
in which:
V represents a leaving group, or chosen from the group consisting of halogens, or Cl, Br and I and sulfonates, or OSO₂Me, OSO₂(C₇H₇) et OSO₂CF₃,
with a precursor of a grafting group of a group Q′, particularly sodium azide,
Q′ represents a group selected from the salen ligand precursor group, or derivatives of salicylaldehyde and or the 3-(tert-butyl)-5-triazol-2-hydroxybenzaldehyde,
to obtain a compound of formula (VIII) 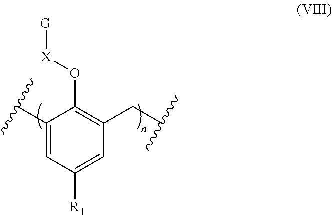
in which:
G represents a grafting group of said group Q′, or a N₃ group,
and comprising a step of contacting said compound of formula (VIII) with said group Q′
to obtain a compound of formula (IB) 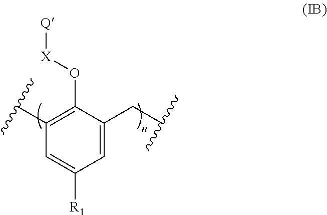
then comprising a step of contacting said compound of formula (IB),
with another precursor group of the salen ligand, or derivatives of salicylaldehyde and or the compound of formula (VII), 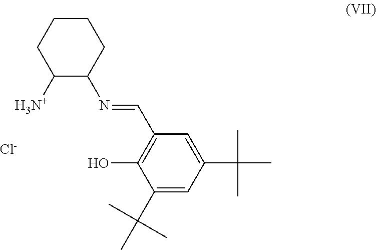 [SMILES: [Cl-] ; CC(C)(C)c1cc(/C=N/C2CCCCC2[NH3+])c(O)c(C(C)(C)C)c1]
to obtain a compound of formula (IA), 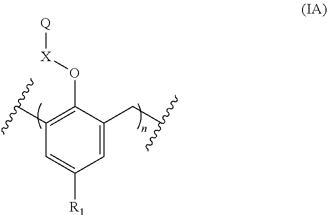
and comprising a step of contacting said compound of formula (IA),
with a metal complex of formula LM^{m+},
wherein:
M^{m+} is a metal in oxidation state m or a metal cluster comprising a plurality of metals in the oxidation state m, where m is 0, 1, 2, 3, 4 or 5,
L consists of one or more neutral ligands or negatively charged linked to the metal,
optionally in the presence of a base, or with cobalt acetate and para-toluenesulfonic acid,
to obtain said compound of formula (IC).

32. Method according to claim 29, wherein said compound of formula (IC) is used as heterogeneous catalyst.

33. Method according to claim 29, wherein the leaching ratio of metal of said catalyst is less than 10%, or less than 5% of the total weight of the metal content in this catalyst.

34. Method according to claim 29, wherein said compound of formula (IC) is used as heterogeneous catalyst, and wherein the leaching ratio of metal of said catalyst is less than 10%, or less than 5% of the total weight of the metal content in this catalyst.
